(19) United States
(12) Patent Application Publication
(10) Pub. No.: US 2024/0238163 A1
(43) Pub. Date: Jul. 18, 2024

(54) MEDICINE DISPENSING APPARATUS

(71) Applicant: TOSHO, INC., Ohta-ku, Tokyo (JP)

(72) Inventors: Yoshihito Omura, Ohta-ku, Tokyo (JP); Syunji Ohgaya, Ohta-ku, Tokyo (JP)

(21) Appl. No.: 18/561,793

(22) PCT Filed: May 23, 2022
(86) PCT No.: PCT/JP2022/021157

§ 371 Date: Nov. 17, 2023

(30) Foreign Application Priority Data
May 25, 2021 (JP) 2021-087327

(51) Int. Cl. A61J 7/00; A61J 1/05

(52) U.S. Cl. CPC A61J 7/0084; A61J 1/05

(57) ABSTRACT

A human burden required to collect remaining medicines from general-purpose medicine feeders is reduced. A medicine dispensing apparatus includes a plurality of medicine feeder storage portions configured to be drawn out of a housing. General-purpose medicine feeders each constituted by integrating a container portion and a successive discharge mechanism portion are mounted in the medicine feeder storage portions. A drawer shelf (drawer mechanism) is provided with a drawn state detecting portion and a remaining medicine collecting container detecting portion. Upon detecting that the medicine feeder storage portion is drawn out and a remaining medicine collecting container is mounted in the medicine feeder storage portion, remaining medicines are discharged from the applicable medicine feeders. Openings of the remaining medicine collecting container are partially exposed when the remaining medicine collecting container is mounted. Marks for alignment are provided. The drawer mechanism is provided with a positioning member.

### TECHNICAL FIELD

The present invention relates to a medicine dispensing apparatus including a plurality of medicine feeders operable to automatically feed solid granular medicines such as tablets and ampules in order to automate medicine dispensation performed in hospitals, pharmacies, etc. In particular the present invention relates to a medicine dispensing apparatus in which a plurality of medicine feeders include a plurality of general-purpose medicine feeders each constituted by integrating a container portion and a successive discharge mechanism portion.

### BACKGROUND ART

A medicine feeder is composed of an upper container portion (follower portion) configured to store medicines and a lower base portion (driving portion) operable to successively discharge medicines therefrom.

So-called special-purpose medicine feeders (medicine feeders exclusively for specific medicines; feeders with a removable container portion) in which a removable medicine cassette is used in a container portion are frequently used as the convenience of the removable cassette is highly evaluated, although the medicine feeders can handle only limited types of medicines (see Patent Documents 1 and 2).

On the contrary, so-called general-purpose medicine feeders (medicine feeders adaptable to many types of medicines; feeders with a fixed container portion) in which a container portion and a base are integrated are highly evaluated for their versatility in handling various types of medicines, and more frequently used as they are improved better (see Patent Documents 4 to 7).

Medicine feeders of a type in which a container portion and a base are integrated will be described. Typical examples of medicine feeders of this type include medicine feeders of an aligned supply type in which tablets etc. (medicines) of the same shape are transferred while being aligned in line. To give one constitution example, a medicine feeder including an outer annular rotary body configured to be axially rotatable about a virtual vertical line, an inclined rotary body provided inside the annular rotary body to be axially rotatable about an inclined line tilted with respect to the virtual vertical line and block the internal space of the annular rotary body, and a regulating member configured to align solid medicines, carried onto the peripheral edge portion at the upper end of the annular rotary body from above through rotation of the inclined rotary body, during rotation of the annular rotary body has been developed, and put into practical use.

### RELATED-ART DOCUMENT

### Patent Document

Patent Document 1: Japanese Unexamined Patent Application Publication No. 2013-146443 (JPA 2013-146443)
Patent Document 2: Japanese Unexamined Patent Application Publication No. 2018-196709 (JPA 2018-196709)
Patent Document 3: Japanese Unexamined Patent Application Publication No. 2007-209600 (JPA 2007-209600)
Patent Document 4: Japanese Unexamined Patent Application Publication No. 2018-108277 (JPA 2018-108277)
Patent Document 5: Japanese Unexamined Patent Application Publication No. 2021-029378 (JPA 2021-029378)
Patent Document 6: Japanese Patent No. 6736074 (JPB 6736074)
Patent Document 7: Japanese Patent No. 6736075 (JPB 6736075)

### SUMMARY OF INVENTION

### Technical Problem

In the general-purpose medicine feeders in which a medicine storage portion and a driving portion are integrated (see Patent Documents 4 to 7), a cassette cannot be replaced since a removable cassette is not provided, unlike the special-purpose medicine feeders with a removable medicine storage cassette (see Patent Documents 1 and 2), and further unlike a manual medicine dispensing device with a removable preliminary dispensing cassette (see Patent Document 3).

Therefore, in order to collect remaining medicines from the general-purpose medicine feeders mounted in the medicine dispensing apparatus, either so-called “remaining medicine collection with use of dispensing paper” collects medicines to be packed in dispensing paper, or so-called “remaining medicine collection with use of individual container” collects medicines to be released into a collecting container located therebelow.

In the former “remaining medicine collection with use of dispensing paper”, which can be implemented by only enhancing a control function without the need to add a mechanical member, package bodies with medicines to be dispensed and package bodies to be collected with remaining medicines not to be dispensed are mixed in a sequence of a group of packages, thereby requiring the utmost attention to handle the group of packages such as the separation of such packages and tending to take a long time since collection of remaining medicines until next dispensation.

In contrast with the above, in the latter “remaining medicine collection with use of individual container”, releases medicines from the target medicine feeders into a collecting container located therebelow for collection with the general-purpose medicine feeders being drawn out of a housing of the medicine dispensing apparatus in which the medicine feeders are mounted and with the collecting container being located immediately therebelow. Thus, there are no package bodies to be collected containing remaining medicines not to be dispensed, thereby eliminating the need for the separation work described above and requiring only a short time to collect the remaining medicines.

Attempts at “remaining medicine collection with use of individual container” are highly evaluated, whereby the general-purpose medicine feeders are drawn out of the housing and medicines are released into the collecting container located therebelow. There are still requests for further improvement. Specifically, a worker is occupied during remaining medicine collection, since remaining medicine collection is performed for a single medicine feeder and with the collecting container being held by a human hand. When there are a plurality of medicine feeders to be subjected to remaining medicine collection, the amount of work and hence the burden on the worker are increased as the work is consecutively performed. The burden on the worker is also increased when it is requested to grasp the correlation between the medicine feeder from which remaining medicines are collected and the collected remaining medicines and hence the type of the collected remaining medicines, in order to reuse the collected remaining medicines without being wasted.

Thus, there is a technical issue in improving the function and workability of collecting remaining medicines in a medicine dispensing apparatus configured to support “remaining medicine collection with use of individual container” in which general-purpose medicine feeders are drawn out of a housing and medicines are released into a collecting container located therebelow, in order to further reduce a human burden required for remaining medicine collection.

### Solution to Problem

A medicine dispensing apparatus according to the present invention has been proposed to address the above issue. The medicine dispensing apparatus according to the present invention includes: a plurality of medicine feeders each including a container portion for containing a large number of medicines in a random manner and a successive discharge mechanism portion operable to drop and discharge the large number of medicines one by one downward from the container portion; a packing device operable to receive and pack the medicines discharged from the plurality of medicine feeders; a housing capable of accommodating the plurality of medicine feeders and the packing device; and a control portion configured to control operation of the plurality of medicine feeders and the packing device. The plurality of medicine feeders include a plurality of general-purpose medicine feeders each constituted by integrating the container portion and the successive discharge mechanism portion. The plurality of general-purpose medicine feeders are separately mounted on a plurality of drawer shelves that are drawable forward out of the housing. The plurality of drawer shelves are each provided with a drawn state detecting portion configured to detect a drawn state of the drawer shelf and a remaining medicine collecting container detecting portion configured to detect whether or not a removable remaining medicine collecting container is mounted ahead of a medicine discharge port of one or more general-purpose medicine feeders, among the plurality of general-purpose medicine feeders mounted on the drawer shelf that has been drawn out. When the remaining medicine collecting container detecting portion detects that the remaining medicine collecting container is mounted to the one or more general-purpose medicine feeders mounted on the drawer shelf that has been drawn out when the drawn state detecting portion detects that the drawer shelf is drawn out forward, the control portion causes the applicable general-purpose medicine feeders to execute remaining medicine discharge operation.

In the medicine dispensing apparatus according to the present invention, when it is automatically confirmed for a general-purpose medicine feeder that the relevant medicine feeder has been drawn forward out of the housing and that a remaining medicine collecting container has been mounted in correspondence with the medicine discharge port, medicines are discharged from the relevant medicine feeder. Thus, it is automatically confirmed whether or not remaining medicine collecting operation can be performed, and remaining medicine collecting operation can be automatically performed once such operation is started. Therefore, a human burden required for remaining medicine collection can be significantly reduced.

Specifically, the control portion includes: a medicine dispensation instruction receiving portion configured to receive a medicine dispensation instruction, and a remaining medicine collecting instruction receiving portion configured to receive a remaining medicine collecting instruction for instructing the plurality of general-purpose medicine feeders to release remaining medicines in a state of being drawn out forward. When the drawn state detecting portion detects that the drawer shelf is drawn out forward and the remaining medicine collecting container detecting portion detects that the remaining medicine collecting container is mounted, the remaining medicine collecting instruction receiving portion causes the corresponding general-purpose medicine feeders to execute the remaining medicine discharge operation.

Preferably, the remaining medicine collecting container includes a plurality of remaining medicine collecting portions corresponding to all the general-purpose medicine feeders mounted on one of the drawer shelves. With this configuration, remaining medicines can be immediately collected from the plurality of medicine feeders by mounting one remaining medicine collecting container to one drawer shelf.

Preferably, the drawer shelf is provided with one or more shelf-side marks for alignment corresponding to one or more container-side marks provided on the remaining medicine collecting container. In this case, preferably, the drawer shelf and the remaining medicine collecting container are configured such that, when the remaining medicine collecting container is mounted on the drawer shelf with the one or more container-side marks corresponding to the one or more shelf-side marks, openings of the plurality of remaining medicine collecting portions of the remaining medicine collecting container face medicine discharge ports of the plurality of general-purpose medicine feeders and the remaining medicine collecting container detecting portion detects that the remaining medicine collecting container is mounted. With this configuration, when the remaining medicine collecting container is mounted to the drawer shelf with the marks corresponding to each other, the openings of the remaining medicine collecting portions of the remaining medicine collecting container are located at the medicine discharge ports of the general-purpose medicine feeders, and mounting of the remaining medicine collecting container is detected by the remaining medicine collecting container detecting portion, which facilitates the work of mounting the remaining medicine collecting container.

The drawer shelf and the remaining medicine collecting container are configured such that a part of the remaining medicine collecting container is engaged with a part of the drawer shelf to suppress misalignment between the remaining medicine collecting container and the drawer shelf when the remaining medicine collecting container is mounted on the drawer shelf with the one or more container-side marks and the one or more shelf-side marks corresponding to each other.

The drawer shelf and the remaining medicine collecting container may be configured such that some of openings of the plurality of remaining medicine collecting portions of the remaining medicine collecting container are exposed when the remaining medicine collecting container is mounted on the drawer shelf with the one or more container-side marks and the one or more shelf-side marks corresponding to each other. With this configuration, some of the openings of the remaining medicine collecting container are exposed to allow the state of remaining medicine collection to be visually checked through the exposed portions of the openings. Thus, it is possible to visually see whether or not there are collected remaining medicines easily and shortly, even without the need to wait until the remaining medicine collecting container is detached.

Preferably, the drawer shelf and the remaining medicine collecting container are configured to be removably attached through mount-unmount means that uses a magnetic force of one or more permanent magnets. With this configuration, the mount-unmount means can be implemented easily and inexpensively.

Preferably, the one or more permanent magnets are mounted to the remaining medicine collecting container; and a mount-unmount portion of the drawer shelf is formed from a magnetic material. With this configuration, the remaining medicine collecting container which is removable can be retained by a magnetic force on an outside surface etc. of the housing when not in use, and thus can be stored without being an obstacle when not in use, and can be taken by hand easily and immediately to be used.

Further, preferably, a part of the housing is formed from a magnetic material so that the remaining medicine collecting container is mountable thereto using the magnetic force when the remaining medicine collecting container is not in use. With this configuration, the remaining medicine collecting container which is removable can be retained by a magnetic force on an outside surface etc. of the housing when not in use, and thus can be stored without constituting an obstruction when not in use, and can be taken by hand easily and immediately used.

The control portion may include data holding means for holding record data about some of the plurality of general-purpose medicine feeders having discharged medicines based on a medicine dispensation instruction and record data about others of the plurality of general-purpose medicine feeders having discharged medicines for collecting remaining medicines. In this case, the control portion may limit the remaining medicine discharge operation to general-purpose medicine feeders having discharged medicines based on the medicine dispensation instruction but not having discharged medicines for collecting remaining medicines thereafter by referencing the record data. With this configuration, useless operation of medicine feeders clearly storing no remaining medicines can be avoided.

### BRIEF DESCRIPTION OF DRAWINGS

FIG. 1 is a schematic diagram illustrating a schematic configuration of a medicine dispensation system including a medicine dispensing apparatus according to an embodiment of the present invention.

FIG. 2 illustrates the structure of the entire medicine dispensing apparatus, wherein FIG. 2A is a front view illustrating the exterior thereof and FIG. 2B is a front view illustrating the interior thereof.

FIGS. 3A to 3D are each a left side view of the medicine dispensing apparatus, and FIG. 3E is a perspective view of a front surface of a medicine storage portion.

FIGS. 4A to 4C are each a perspective view of a medicine feeder storage portion.

FIGS. 5A and 5B are each a left side view of the medicine dispensing apparatus, and FIGS. 5C to 5E are each a perspective view of an upper medicine collecting portion.

FIG. 6 illustrates an essential portion of a drawer lock mechanism, wherein FIG. 6A is a front view, FIG. 6B is a plan view, and FIGS. 6C and 6D are each a front view.

FIG. 7A is a front view of a medicine feeder (special-purpose medicine feeder) exclusively for specific medicines with a cassette being removed, and FIG. 7B includes a left side view, a front view, and a right side view of a medicine feeder (general-purpose medicine feeder) adaptable to many types of medicines.

FIG. 8A is a functional block diagram of a control portion for the medicine dispensing apparatus and control portions for the medicine feeders, and FIGS. 8B to 8E are each an example of screen display on a touch panel.

FIG. 9 illustrates a remaining medicine collecting container, wherein FIG. 9A is an exterior perspective view, FIG. 9B is a perspective view of permanent magnets and a mark for attachment and removal, and FIG. 9C is a two-point perspective view as seen along an arrow C.

FIG. 10 illustrates a situation in which an attempt is made to mount the remaining medicine collecting container to the medicine feeder storage portion, wherein FIG. 10A is a perspective view of the remaining medicine collecting container immediately before being mounted and the medicine feeder storage portion standing by for mounting of the remaining medicine collecting container, FIG. 10B is a perspective view illustrating a portion with a mark of the remaining medicine collecting container and a mark of the medicine feeder storage portion as enlarged, and FIG. 10C is a two-point perspective view of abutment portions of the remaining medicine collecting container before being mounted and the medicine feeder storage portion.

FIG. 11 illustrates a state in which the remaining medicine collecting container has been mounted to the medicine feeder storage portion, wherein FIG. 11A is an exterior perspective view of the medicine feeder storage portion and FIG. 11B is an exterior perspective view of the medicine dispensing apparatus.

FIGS. 12A to 12D are each an example of screen display on the touch panel, and FIG. 12E is an exterior perspective view in which the remaining medicine collecting container that has been used is mounted to a side surface of a housing of the medicine dispensing apparatus.

### DESCRIPTION OF EMBODIMENTS

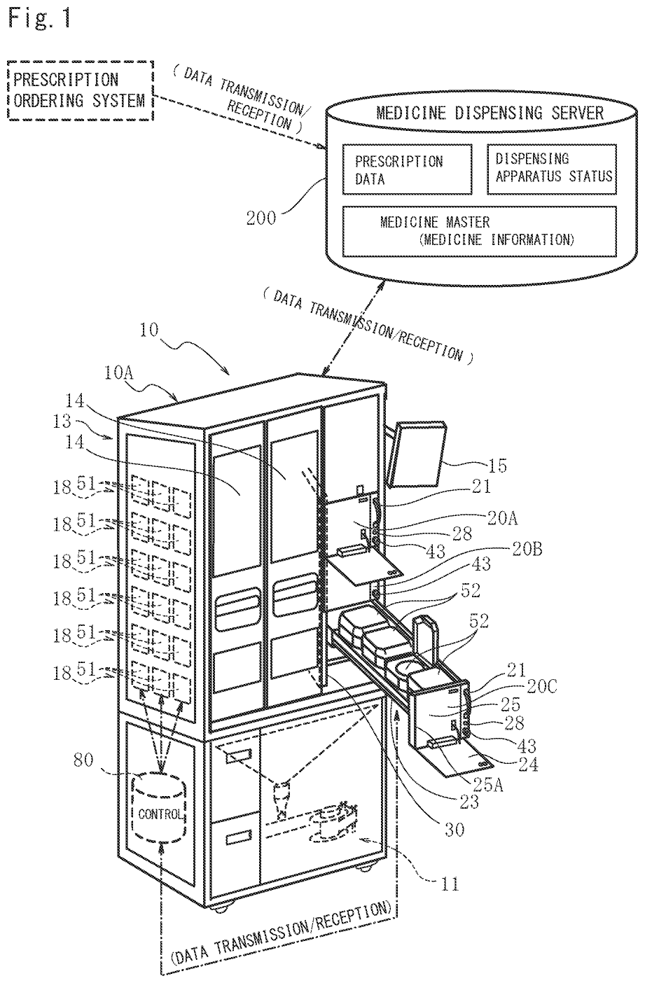

A medicine dispensing apparatus according to an embodiment of the present invention will be described in detail below with reference to FIGS. 1 to 12.

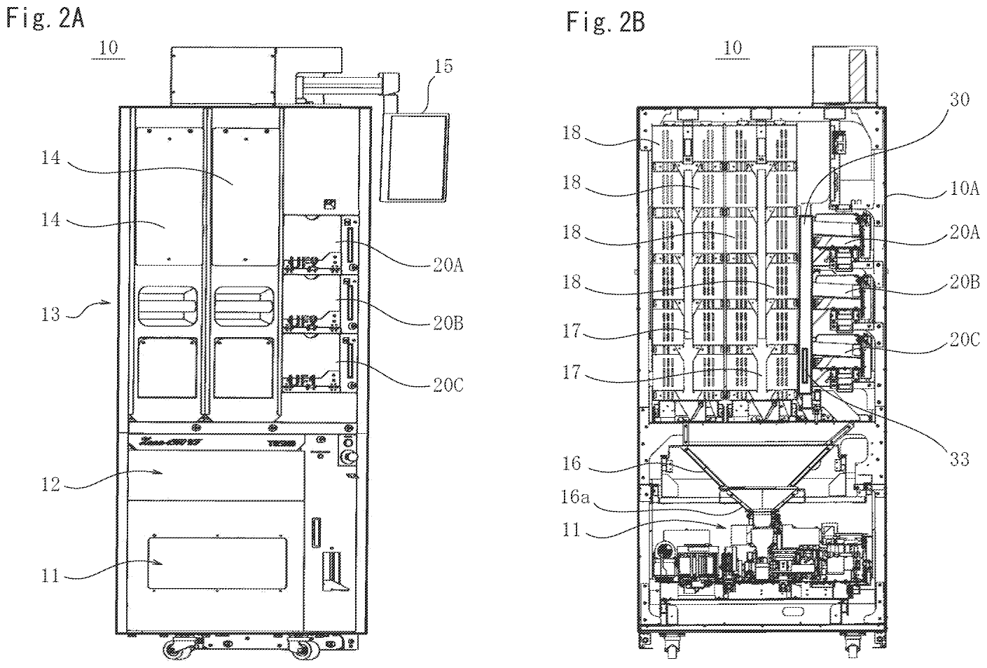

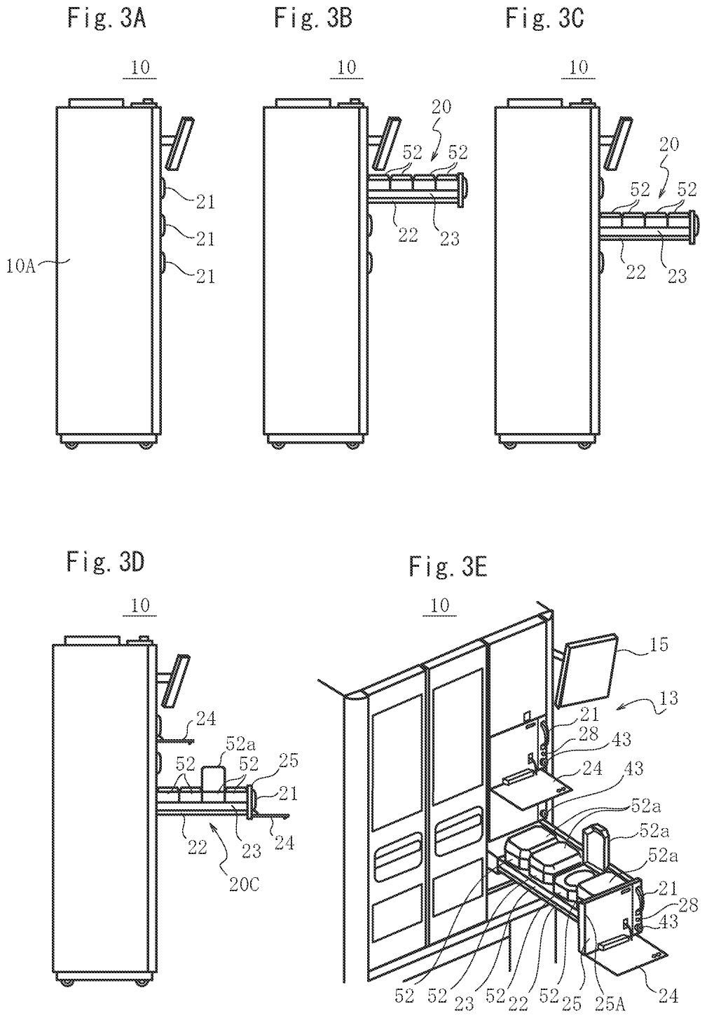

FIG. 1 is a schematic diagram illustrating a schematic configuration of a medicine dispensation system including a medicine dispensing apparatus 10 according to the present embodiment. FIGS. 2 and 3 illustrate the structure of the entire medicine dispensing apparatus 10, wherein FIG. 2A is a front view illustrating the exterior thereof, FIG. 2B is a front view illustrating the interior thereof, and FIGS. 3A to 3D are each a left side view illustrating the exterior thereof.

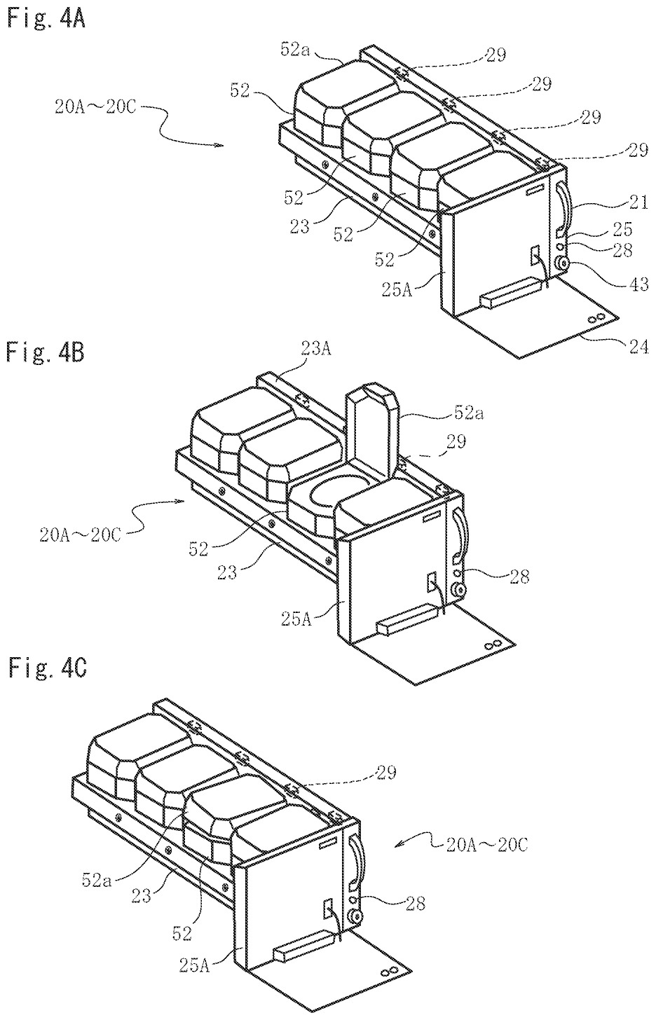

FIG. 3E is a perspective view of a front surface of a medicine storage portion 13, and FIGS. 4A to 4C are each a perspective view of a medicine feeder storage portion 20.

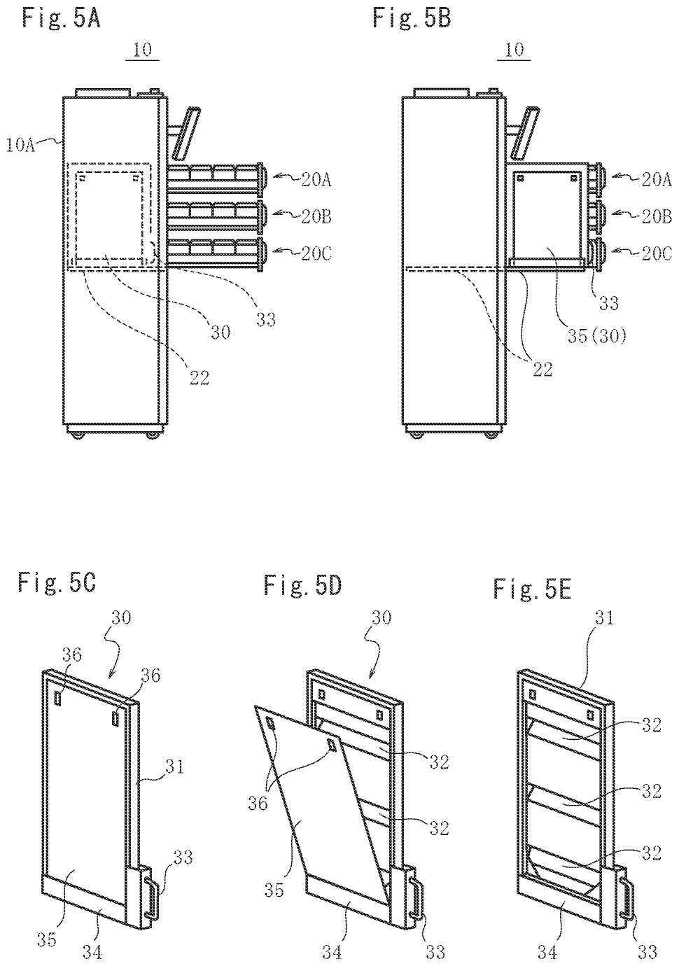

FIGS. 5A and 5B are each a left side view of the medicine dispensing apparatus 10, and FIGS. 5C to 5E are each a perspective view of an upper medicine collecting portion 30.

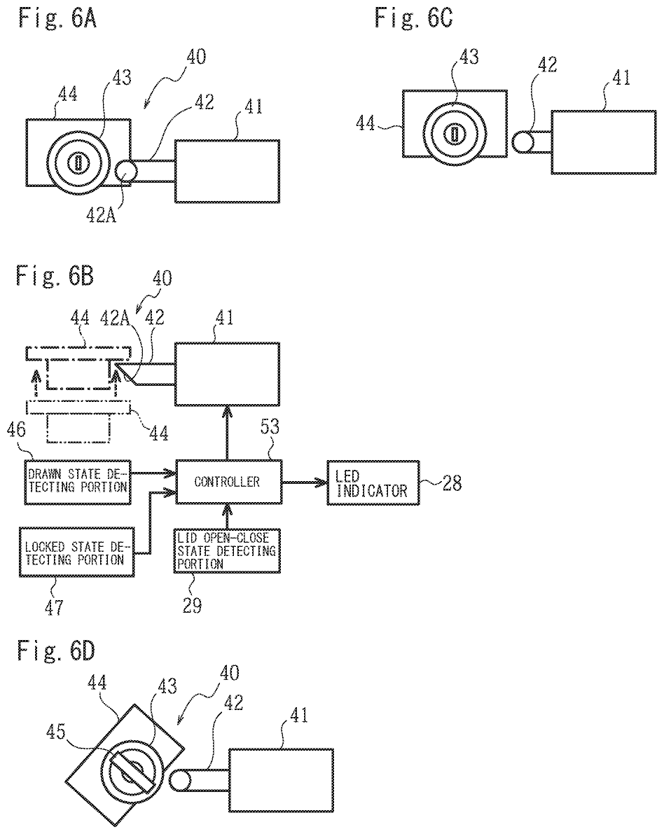

FIG. 6 illustrates an essential portion of a drawer lock mechanism 40, in which FIG. 6A is a front view, FIG. 6B is a plan view of the drawer lock mechanism 40 with the addition of determination means, and FIGS. 6C and 6D are each a front view.

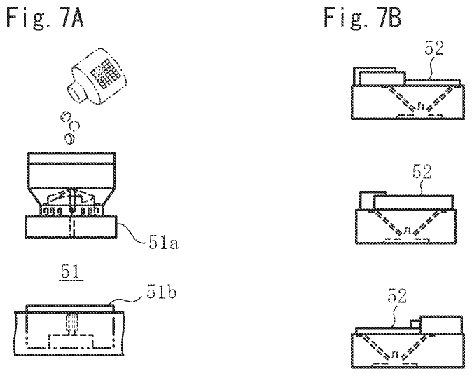

FIG. 7 illustrates two different types of medicine feeders, in which FIG. 7A is a front view of a medicine feeder 51 (special-purpose medicine feeder) of a cassette mount-unmount type exclusively for specific medicines and FIG. 7B illustrates the exterior of a medicine feeder 52 (general-purpose medicine feeder) adaptable to many types of medicines, including a left side view, a front view, and a right side view arranged in this order from the top.

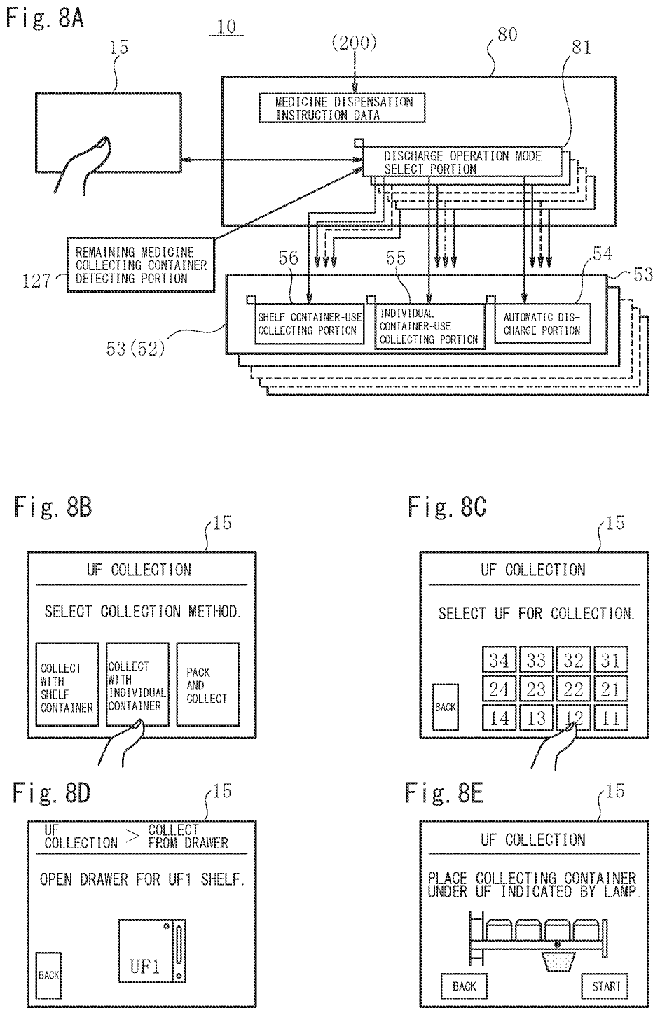

FIG. 8A is a functional block diagram of a controller 80 (main control portion) for the medicine dispensing apparatus 10 and controllers (sub control portions) for medicine feeders 52, and FIGS. 8B to 8E are each an example of screen display on a touch panel 15.

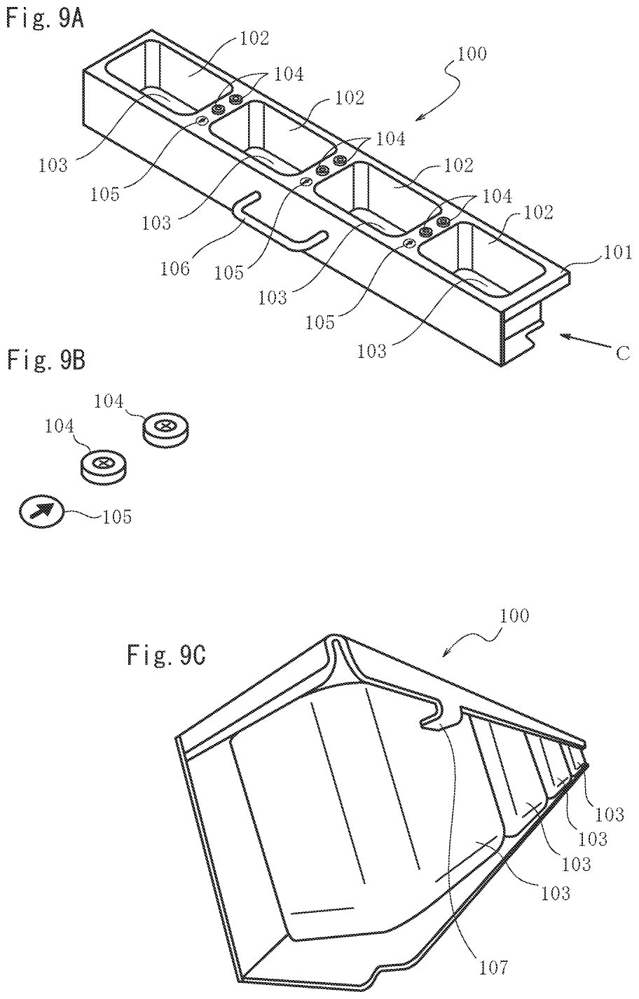

FIG. 9 is an exterior perspective view of a remaining medicine collecting container 100, in which FIG. 9A is an exterior perspective view as seen obliquely from above, FIG. 9B is an enlarged view of permanent magnets 104 and a mark 105 for attachment and removal, and FIG. 9C is a two-point perspective view as seen along an arrow C obliquely from below.

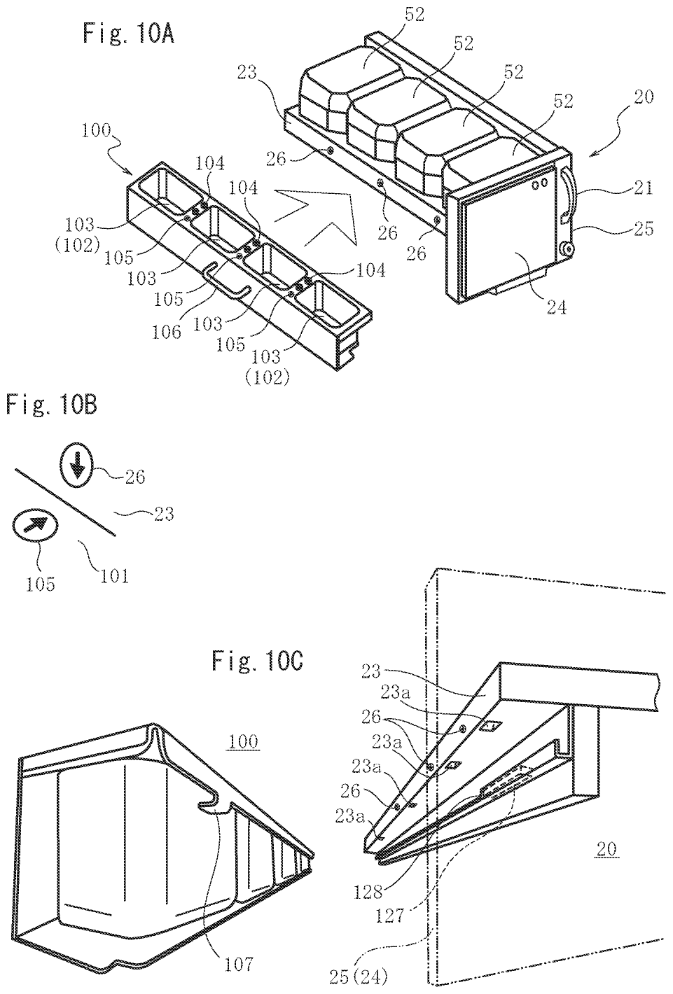

FIG. 10 illustrates a situation in which an attempt is made to mount the remaining medicine collecting container 100 to the medicine feeder storage portion 20, in which FIG. 10A is a perspective view of the container 100 immediately before being mounted and a drawer shelf 23 standing by for mounting of the container 100, FIG. 10B is a perspective view illustrating a portion with a mark 105 of the remaining medicine collecting container 100 and a mark 26 of the medicine feeder storage portion 20 as enlarged, and FIG. 10C is a two-point perspective view of abutment portions 107, 128 of the remaining medicine collecting container 100 before being mounted and the medicine feeder storage portion 20.

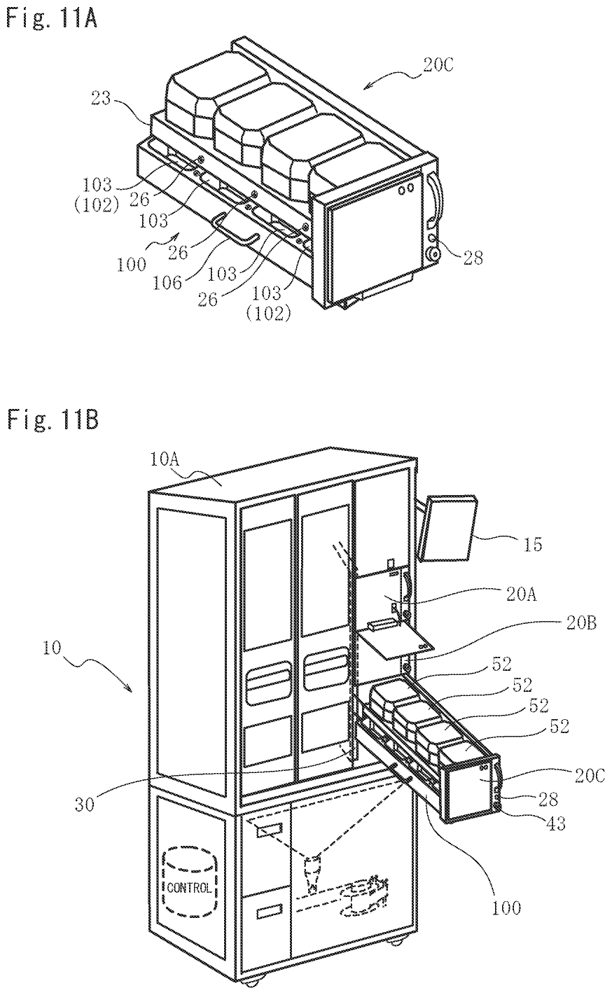

FIG. 11 illustrates a state in which the remaining medicine collecting container 100 has been mounted to the medicine feeder storage portion 20, in which FIG. 11A is an exterior perspective view of the medicine feeder storage portion 20 and FIG. 11B is an exterior perspective view of the medicine dispensing apparatus 10.

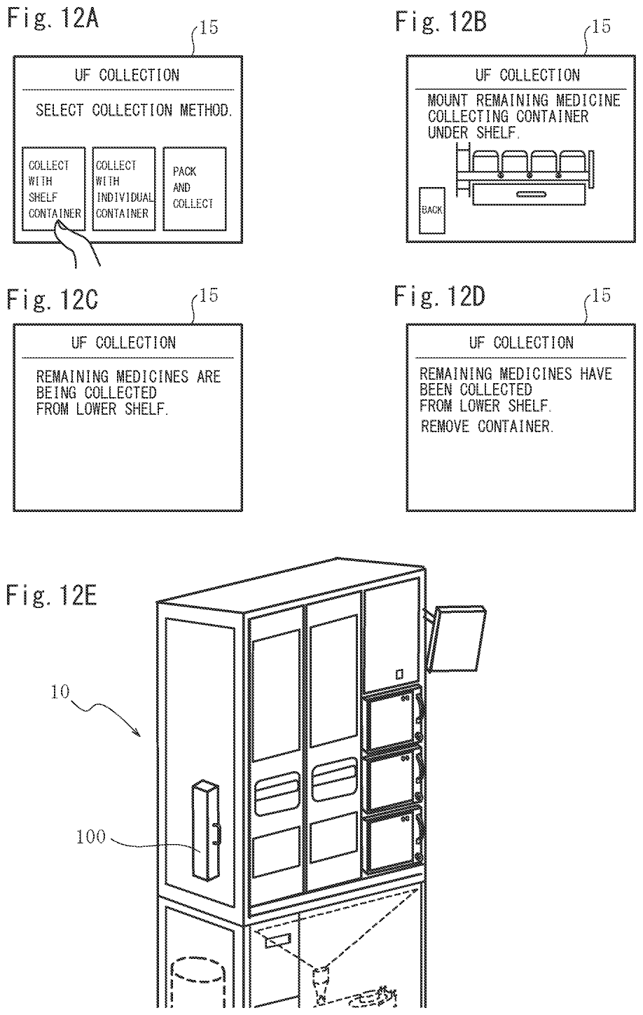

FIGS. 12A to 12D are each an example of screen display on the touch panel 15, and FIG. 12E is an exterior perspective view in which the remaining medicine collecting container 100 that has been used is mounted to a side surface of a housing 10A of the medicine dispensing apparatus 10.

The medicine dispensing apparatus 10 (see FIG. 1) is occasionally used singly in a small-scale pharmacy etc., but a plurality of medicine dispensing apparatuses 10 are often used under a medicine dispensing server 200 in a large-scale medicine dispensation department.

The medicine dispensing server 200 can transmit and receive data to and from a prescription ordering system on the upper level and a medicine dispensing apparatus 10 on the lower level via a LAN etc. The medicine dispensing server 200 receives medicine dispensation instruction data from the prescription ordering system and holds such data, and issues a medicine dispensation instruction to an applicable one of the medicine dispensing apparatus 10 and other medicine dispensing apparatuses (not illustrated), if any, based on the medicine dispensation instruction data. In addition, the medicine dispensing server 200 holds data on the operation state of the medicine dispensing apparatus 10 as a dispensing apparatus status, and also holds a medicine master in which known medicine information on various types of medicines has been registered in advance.

The medicine dispensing apparatus 10 (see FIGS. 1 and 2A) includes a packing device 11 at a lower portion, a manual medicine dispensing device 12 located thereabove, a medicine storage portion 13 located further thereabove, a touch panel 15 (operation input portion; display portion) supported by an arm so as to be easily changeable in position, and a controller 80 (control portion for the medicine dispensing apparatus) stored inside the housing 10, and a plurality of medicine feeder storages 14 and a plurality of medicine feeder storage portions 20A to 20C are assembled in the medicine storage portion 13 so as to be drawn out forward.

While two columns of medicine feeder storages 14 laterally arranged side by side are illustrated, there may be three or more columns of medicine feeder storages 14 laterally arranged side by side or a single column of medicine feeder storage 14, and each column may further be vertically divided into upper and lower sections such that each section can be drawn out forward.

While the medicine feeder storage portions 20 are arranged in a single column laterally and three rows vertically in the drawings, the medicine feeder storage portions 20 may be arranged differently as long as the medicine feeder storage portions 20 are arranged in two or more rows vertically.

Standard medicine feeder storage portions 18, in which a plurality of medicine feeders 51 exclusively for specific medicines (special-purpose medicine feeders; see FIGS. 1 and 7A) are arranged in the front-rear direction, are mounted inside the medicine feeder storages 14 in the medicine storage portion 13, which occupies the upper portion of the medicine dispensing apparatus 10, as arranged in six rows vertically and two columns horizontally, and a standard upper medicine collecting portion 17 is provided to vertically penetrate between the two columns of standard medicine feeder storage portions 18 (see FIG. 2B). Medicines discharged from the special-purpose medicine feeders 51 are guided by the standard upper medicine collecting portions 17 to the lower medicine collecting portion 16 therebelow.

In addition (see FIGS. 1 and 2B), the upper medicine collecting portion 30 is also provided inside a location at which the medicine feeder storage portions 20A to 20C are disposed (see FIGS. 1, 2B, and 5), occupying a corner of the medicine storage portion 13 and hidden behind front panels 25, as will be discussed later, of the medicine feeder storage portions 20A to 20C (see FIGS. 3D and 3E). A handle 33 provided on the front surface of the upper medicine collecting portion 30 is also hidden behind the front panels 25. While the upper medicine collecting portion 30 guides medicines discharged from feeders to the lower medicine collecting portion 16 therebelow as with the standard upper medicine collecting portions 17, the upper medicine collecting portion 30 receives medicines discharged from the medicine feeders 52 (general-purpose medicine feeders) adaptable to many types of medicines of the medicine feeder storage portions 20A to 20C, rather than medicines discharged from the medicine feeders 51 (special-purpose medicine feeders) exclusively for specific medicines of the standard medicine feeder storage portions 18. The upper medicine collecting portion 30 receive medicines from not only one but also the three medicine feeder storage portions 20A to 20C continuously arranged vertically.

The medicine feeder storage portions 20A to 20C illustrated in the drawing (see FIG. 3) are each provided with a handle 21 on the front surface (see FIG. 3A), and each supported by a drawer shelf 23 of a drawer mechanism 22 (see FIG. 3B) such that the medicine feeder storage portions 20A to 20C in the upper to lower rows can be individually drawn out forward and pushed in rearward (see FIGS. 3A to 3D). In addition (see FIGS. 3D, 3E, and 4), four medicine feeders 52 (general-purpose medicine feeders) are mounted on the drawer shelf 23, which is supported by the drawer mechanism 22, to be arranged in line in the front-rear direction. Further, a movable rack 24, a manual lock 43, an LED indicator (not illustrated), etc. are also provided, besides the handle 21, on the front panel 25 (see FIGS. 3E and 4A) at the front end of the medicine feeder storage portions 20A to 20C.

Unlike the medicine feeders 51 (special-purpose medicine feeders) exclusively for specific medicines to be almost always filled with medicines of the same type, the medicine feeders 52 (general-purpose medicine feeders) adaptable to many types of medicines can be selectively used for medicines of a variety of shapes and sizes (also see Patent Documents 4 to 6) by making simple adjustments thereto as discussed already, specifically by changing a sample medicine or acquiring medicine dimension data from the medicine dispensing server 200, for example. Therefore, from the viewpoint of suppressing the occurrence of an error such as a mistake of medicines during medicine replenishment work as much as possible, medicine feeders of a so-called “unit-all-fixed type” in which a medicine storage portion also is normally fixed, except during maintenance work, are adopted. In the present embodiment, although not essential, the medicine feeders 52 each include a built-in controller 53 illustrated in FIG. 6B, and the controller 53 is configured to transmit and receive data to and from the controller 80 illustrated in FIG. 8 to constitute a control portion in cooperation therewith.

In addition (see FIGS. 3D, 3E, and 4), the medicine feeder storage portions 20A to 20C are provided with a lid 52a and a lid open-close state detecting portion 29 in correspondence with each of the medicine feeders 52 mounted therein.

The lid 52a is provided to open and close a medicine input port on the upper surface of the corresponding medicine feeder 52 (general-purpose medicine feeders) adaptable to many types of medicines, with the rear end portion (upper right portion in the drawings) of the lid 52a being supported by a shaft to be swingable. The lid 52a closes the medicine input port when the lid 52a is in a horizontal state (see FIG. 4A), and opens the medicine input port to a state enabling input of medicines when the lid 52a is in a vertical or substantially vertical state (see FIG. 4B). The lid 52a is displaced between the closed state and the open state.

The lid open-close state detecting portion 29 (see FIG. 4A is mainly composed of a photosensor, for example, and attached to a back plate portion 23A of the drawer shelf 23. The lid open-close state detecting portion 29 is located in rear of the corresponding medicine feeder 52 adaptable to many types of medicines to detect the open-close state of the corresponding lid 52a using a photosensor (not illustrated) provided in the lid 52a. The lid open-close state detecting portion 29 does not only detect whether or not the corresponding lid 52a is sufficiently open to a state enabling input of medicines (see FIG. 4B), but also detects whether the lid 52a is sufficiently closed to a state hindering an overflow of medicines (see FIG. 4C). Detection of these states can be implemented not only by using a plurality of magnetic sensors with different sensitivity levels, but also by comparing an output value of a single magnetic sensor with a plurality of thresholds at different levels. The results of the detection by the lid open-close state detecting portion 29 are sent to the controller 80 for the medicine dispensing apparatus 10 via the controller 53 [FIG. 6B] provided in the medicine feeder 52.

The controller 80 (FIG. 8) which manages input of medicines etc. determines that input of medicines to the corresponding medicine feeder 52 has been started when it is found based on the values detected by the lid open-close state detecting portion 29 that the corresponding lid 52a has been opened from a sufficiently closed state (see FIG. 4A) to a state enabling input of medicines (see FIG. 4B).

In addition, the controller 80 determines that input of medicines to the corresponding medicine feeder 52 has been completed when it is found based on the values detected by the lid open-close state detecting portion 29 that the lid 52a has been sufficiently closed from a state in which the lid 52a is open to a state in which the lid 52a can hinder an overflow of medicines (see the change from FIG. 4B to FIG. 4A).

The lower end portion of the movable rack 24 is coupled to the lower end portion of the front surface of the front panel 25 via a swing support shaft (see FIGS. 3D, 3E, and 4) so that the movable rack 24 can be easily swung by a hand or a fingertip. When the free swing end of the movable rack 24 is raised (see FIGS. 3A to 3C), the movable rack 24 is brought into a vertical posture as if the movable rack 24 were stuck to the front panel 25. In contrast, when the free swing end of the movable rack 24 is lowered (see FIGS. 3D, 3E, and 4), the movable rack 24 is brought into a horizontal posture like a small table to allow small articles such as a medicine bottle and a medicine dispensation instruction slip to be placed thereon.

As illustrated in FIGS. 5A and 5B, the upper medicine collecting portion 30 is disposed directly at a side of the three medicine feeder storage portions 20A to 20C to guide medicines discharged from the medicine feeder storage portions 20A to 20C downward and allow the medicines to fall. The upper medicine collecting portion 30 is supported by the drawer mechanism 22 inside the medicine storage portion 13 (see FIGS. 5A and 5B), and can be drawn forward out of the medicine storage portion 13 (see FIG. 5B). The upper medicine collecting portion 30 is shorter in the length in the front-rear direction than the medicine feeder storage portions 20A to 20C, and is always located in rear of left end portions 25A of the front panels 25 of the medicine feeder storage portions 20A to 20C on the right side (see FIGS. 1, 2, 4A, and 4B).

The front panels 25, the left end portions 25A of which project to the front side of the upper medicine collecting portion 30, each constitute relative draw-out position regulation means for hindering the upper medicine collecting portion 30 from being drawn forward out of the medicine feeder storage portions 20. The left end portions 25A also serve as members configured to regulate the upper medicine collecting portion 30 being drawn forward out of the medicine storage portion 13. The medicine feeder storage portions 20A to 20C provided with such front panels 25 are provided only on the right side of the right and left sides of the upper medicine collecting portion 30 (see FIG. 2B). There are no regulation members such as the front panels 25 on the left side of the upper medicine collecting portion 30. As a result, the left side of the upper medicine collecting portion 30 is released when the upper medicine collecting portion 30 is drawn forward out of the medicine storage portion 13 (see FIG. 5B).

Further, the upper medicine collecting portion 30 (see FIGS. 5C to 5E) is mainly composed of a shallow box-shaped body portion 31, and a removable side plate 35 disposed on a releasable side surface on the left side, corresponding to one of the two side surfaces of the body portion 31 that is the farther from the medicine feeder storage portions 20A to 20C, to close the side surface when mounted. Medicine receiving ports 32 are formed to open in a right side plate of the body portion 31 to receive medicines discharged from the medicine feeder storage portions 20A to 20C. The handle 33 is provided at the front end of the body portion 31. A side plate holding member 34 is provided at a position at the lower end portion of the body portion 31 and under the releasable side surface to receive the lower end portion of the side plate 35 from the lower side.

Small retention members 36 of a lever operation type, for example, are provided at the upper portion of the side plate 35. The releasable side surface of the body portion 31 is closed (see FIG. 5C) when the lower end portion of the side plate 35 is placed on and received by the side plate holding member 34 and then the side plate 35 is caused to stand upright with the retention members 36 being engaged with the body portion 31. Meanwhile, the upper portion of the side plate 35 is released from the releasable side surface of the body portion 31 (see FIG. 5D) when the retention members 36, 36 are all disengaged. The side plate holding member 34 includes a latch structure to hold the side plate 35. The side plate 35 is completely released from the body portion 31 to significantly expose the inside of the body portion 31 (see FIG. 5E) when the side plate 35 is lifted with hands at both the left and right ends of the side plate 35, for example.

As discussed above (see FIGS. 3E and 4A), the manual lock 43 is provided on the front panel 25 of the medicine feeder storage portion 20. As illustrated in FIG. 6, the drawer lock mechanism 40 including the manual lock 43 is constituted by members mounted to the front end portions of the medicine feeder storage portions 20A to 20C and the front end portion of the medicine storage portion 13. Specifically, the drawer lock mechanism 40 illustrated in FIG. 6 includes a swing member 44 provided on the medicine feeder storage portions 20A to 20C together with the manual lock 43, an electromagnetic driving portion 41 provided at a frame portion of the medicine storage portion 13, and an advancing-retracting member 42 capable of advancing from the electromagnetic driving portion 41 toward the swing member 44 and retracting in the other way. The advancing-retracting member 42 is always biased toward the advanced side (leftward) by a spring etc. (not illustrated) to project from the frame portion of the medicine storage portion 13 toward the medicine feeder storage portion 20, and the medicine feeder storage portion 20 is brought into a locked state in which the medicine feeder storage portion 20 cannot be drawn forward out of the medicine storage portion 13 when the distal end portion of the advancing-retracting member 42 is located in front of the swing member 44 (see FIG. 6A).

Moreover (see FIG. 6B), an inclined surface 42A is formed at the distal end portion of the advancing-retracting member 42. When the swing member 44 abuts against the inclined surface 42A, the advancing-retracting member 42 is retracted toward the electromagnetic driving portion 41 (moved rightward in the drawing) by a component force due to the abutment. When the medicine feeder storage portion 20 which has been drawn out is pushed into the medicine storage portion 13, the swing member 44 temporarily retracts the advancing-retracting member 42 to be moved rearward (see the dash-double-dot line and the dot and dash line in FIG. 6B) and thereafter advanced back to the original position. While the drawer shelf 23 of the medicine feeder storage portions 20A to 20C is normally locked when the drawer shelf 23 is to be drawn out, the drawer shelf 23 of the medicine feeder storage portions 20A to 20C can be pushed in any time.

As illustrated in FIG. 6B, the medicine feeder storage portions 20A to 20C are each provided with a drawn state detecting portion 46 configured to detect whether or not the drawer shelf 23 has been drawn out forward, and a locked state detecting portion 47 configured to detect a locked state of the drawer lock mechanism 40 operable to selectively hinder the drawer shelf 23 from being drawn out forward. The drawn state detecting portion 46 and the locked state detecting portion 47 are each constituted using a photosensor, a magnetic sensor, a limit switch, etc. The results of the detection by the drawn state detecting portion 46 and the locked state detecting portion 47 are output to both the controller 53 in the medicine feeder 52 and the controller 80 which constitutes the control portion for the medicine dispensing apparatus illustrated in FIG. 8. It is not essential to provide the locked state detecting portion 47, and cancellation of the locked state may be checked according to detection of the drawn state by the drawn state detecting portion 46, or the locked state of the drawer lock mechanism 40 may be checked according to visual recognition by a worker.

As illustrated in FIG. 6C, further, the advancing-retracting member 42 is also retracted toward the electromagnetic driving portion 41 (moved rightward in the drawing) by an electromagnetic force exceeding the spring force when the electromagnetic driving portion 41 is excited under control by the controller 80, which allows the medicine feeder storage portions 20A to 20C to be not only pushed in but also drawn out. That is, the drawer lock mechanism 40 can be electrically unlocked.

As illustrated in FIG. 6D, when a key 45 is inserted into the manual lock 43 and turned to the unlocked side, the swing member 44 is accordingly rotated into a posture in which the swing member 44 is not engaged with the advancing-retracting member 42, which allows the drawer lock mechanism 40 to be manually unlocked. An LED indicator 28 is turned on and off to indicate which of the medicine feeder storage portions 20A to 20C is to be drawn out and which is not.

When it is determined on a basis of detection by the lid open-close state detecting portions 29 and notifications from the controllers 53 that the lids 52a of the medicine feeders 52 mounted in the medicine feeder storage portions 20A to 20C are securely closed (see FIG. 4A), the controller 80 illustrated in FIG. 8A determines as normal when the medicine feeder storage portions 20A to 20C are pushed into the housing 10A. If not, the controller 80 issues an alarm by flashing on and off the LED indicator 28 or making a buzzer sound, for example, even when the lid 52a is closed to an intermediate state not detected by the lid open-close state detecting portion 29 (see FIG. 4C) and the drawn state detecting portion 46 discussed above detects that the drawer shelf 23 for the relevant one of the medicine feeder storage portions 20A to 20C is pushed into the housing and located within the range in which the drawer lock mechanism 40 can be locked, for example.

As discussed earlier, the special-purpose medicine feeders 51 (see FIG. 7A) are the medicine feeders exclusively for specific medicines discussed earlier, which are of a cassette mount-unmount type composed of the fixed base 51b (driving portion) and the cassette 51a (container portion). When a motor of the base 51b is actuated under control by the controller 80 with the cassette being mounted, medicines are dropped and discharged one by one as the cassette 51a is driven. In contrast, the medicine feeders 52 (see FIG. 7B) are the medicine feeders adaptable to many types of medicines (general-purpose medicine feeders) discussed earlier, in which a container portion and a base are integrated (see Patent Documents 4 to 6), and are normally fixed to the medicine feeder storage portions 20A to 20C. The general-purpose medicine feeders 52 also drop and discharge medicines one by one according to control by the controller 80.

In the medicine dispensing apparatus 10 according to the present embodiment, the controller 80 illustrated in FIGS. 8A and 1 includes a plurality of discharge operation mode select portions 81 provided in correspondence with the plurality of general-purpose medicine feeders 52 to control display on the touch panel 15 and transmit input from the touch panel 15 to the controllers 53 for the plurality of general-purpose medicine feeders 52. The discharge operation mode select portions 81 exhibit the function of displaying a screen on the touch panel 15 and receiving operation input through the touch panel 15 by controlling the touch panel 15. The controller 80 performs automatic processing in a possible range when a medicine dispensation instruction receiving portion (not illustrated) receives a medicine dispensation instruction from the medicine dispensing server 200. In addition, the controller 80 displays a screen for guidance etc. for a medicine dispensing person on the touch panel 15, as necessary, and receives an instruction from the medicine dispensing person. For example, it is assumed that medicines not held in the special-purpose medicine feeders 51 are included in a medicine dispensation instruction, and that a general-purpose medicine feeder 52 is selected for execution of medicine dispensation. At this time, the controller 80 displays an instruction to put medicines into the relevant general-purpose medicine feeder 52 on the screen of the touch panel 15 if help from the medicine dispensing person is necessary.

When preparations for automatic discharge are made with data necessary for automatic discharge etc. being obtained, data for an instruction for automatic discharge are transmitted from the controller 80 for the medicine dispensing apparatus 10 to the controller 53 for the target medicine feeder 52. When the medicine feeder storage portion (20A to 20C) in which the relevant medicine feeder 52 is mounted has been pushed into the housing 10A of the medicine dispensing apparatus 10 (see the medicine feeder storage portions 20A and 20B in the upper and middle rows, among the three upper to lower rows illustrated in FIGS. 1 and 3E), medicines are automatically discharged therefrom. Medicines discharged from the relevant medicine feeder 52 (see FIGS. 2B and 5) are fed into the lower medicine collecting portion 16 via the upper medicine collecting portion 30 used in common for the upper to lower medicine feeder storage portions 20A to 20C, and further fed into the packing device 11.

When a medicine dispensation instruction is received from the medicine dispensing server 200, the controller 80 for the medicine dispensing apparatus 10 performs automatic processing in a possible range, and displays a screen for guidance etc. for a medicine dispensing person and receives an instruction from the medicine dispensing person as necessary. For example, when medicines not held in the special-purpose medicine feeders 51 are included in a medicine dispensation instruction and a general-purpose medicine feeder 52 is selected for execution of medicine dispensation, an instruction to put medicines into the relevant general-purpose medicine feeder 52 is displayed on the screen of the touch panel 15 if help from the medicine dispensing person is necessary.

When preparations for automatic discharge are made with data necessary for automatic discharge etc. being obtained, data for an instruction for automatic discharge are transmitted from the controller 80 for the medicine dispensing apparatus 10 to the controller 53 for the target medicine feeder 52 (see FIGS. 1 and 8A). When the relevant medicine feeder 52 has been pushed into the housing of the medicine dispensing apparatus 10 (see the medicine feeder storage portions 20 in the upper and middle rows, among the three upper to lower rows illustrated in FIGS. 1 and 3E), medicines are automatically discharged therefrom. Medicines discharged from the medicine feeder 52 (see FIGS. 2B and 5) are fed into the lower medicine collecting portion 16 via the upper medicine collecting portion 30 used in common for the upper to lower medicine feeder storage portions 20, and further fed into the packing device 11.

In the present embodiment, each time medicines are discharged and packed on a basis of a medicine dispensation instruction as described above, the controller 80 stores information for specifying the medicine feeder, whether the medicine feeder that has discharged the medicines is a special-purpose medicine feeder 51 or a general-purpose medicine feeder 52, discharge information, and further time data, etc. as recorded data in data holding means such as a hard disk (not illustrated). Additionally, each time medicines are discharged for remaining medicine collection to be discussed next, the controller 80 stores information for specifying the medicine feeder, whether the medicine feeder that has collected the medicines is a special-purpose medicine feeder 51 or a general-purpose medicine feeder 52, information for executing remaining medicine collection, and further time data, etc. as recorded data. So-called log data and history data automatically recorded and stored by the controller 80 for abnormality diagnosis etc. also correspond to recorded data if the data include the above information.

When there remain extra medicines in the general-purpose medicine feeder 52 that has finished automatically discharging medicines, the remaining medicines are to be collected. The medicine dispensing apparatus 10 includes four types of collecting means as means for collecting remaining medicines from the target medicine feeder 52 (see FIG. 8A). Any of the means is implemented through coordination between the controller 80 for the medicine dispensing apparatus 10 and the controller 53 for the medicine feeder 52 to be subjected to remaining medicine collection. The four types of collecting means include three types of collecting means (first to third remaining medicine collecting means) that provide a remaining medicine collecting instruction to instruct the general-purpose medicine feeder 52 to release remaining medicines through display or an operation on the touch panel 15, and one type of collecting means (fourth remaining medicine collecting means) that does not require an operation on the touch panel 15.

The three types of means that use the touch panel 15 will be first described. In the first to third methods of collecting remaining medicines, when a remaining medicine collecting instruction to instruct the general-purpose medicine feeder 52 to release remaining medicines is provided through display and operation input via the touch panel 15, the discharge operation mode select portion 81 of the controller 80 for the medicine dispensing apparatus 10 accordingly selects one of an automatic discharge portion 54, an individual container-use collecting portion 55, and a shelf container-use collecting portion 56, which are constituted by a program in the controller 53 for the medicine feeder 52, as a coordination partner. In the fourth method of collecting remaining medicines, the discharge operation mode select portion 81 selects the shelf container-use collecting portion 56 in response to detection of a remaining medicine collecting container detecting portion 127, as will be discussed later, without using the touch panel 15.

The automatic discharge portion 54 (first remaining medicine collecting means) is configured to perform the “dispensing paper-use remaining medicine collection” discussed earlier, in which remaining medicines are discharged and packed with the medicine feeder storage portion (20A to 20C) in which the target general-purpose medicine feeder 52 is mounted, being pushed into the housing 10A of the medicine dispensing apparatus 10 and locked by the drawer lock mechanism 40. In this case, the collected medicines can be advantageously easily managed by printing the name of the medicines on a portion of the dispensing paper to pack the remaining medicines etc. An automatic discharge portion 54 for use for normal packing performed by specifying the number of medicines to be discharged can be conveniently converted into or used in combination with this automatic discharge portion 54, by operating the number of medicines to be discharged etc.

The individual container-use collecting portion 55 (second remaining medicine collecting means) is configured to execute the “individual container-use remaining medicine collection” discussed earlier (see FIG. 8A). Specifically, the individual container-use collecting portion 55 unlocks the drawer lock mechanism 40 for the medicine feeder storage portion (20A to 20C) in which the general-purpose medicine feeder 52 to be subjected to remaining medicine collection is mounted, and determines that the medicine feeder storage portion (20A to 20C) has been drawn forward out of the housing 10A of the medicine dispensing apparatus 10 upon detecting that the medicine feeder storage portion (20A to 20C) is out of the locked position on a basis of detection by the drawn state detecting portion 46 [FIG. 6B]. When one of the medicine feeders 52 receives an instruction to release remaining medicines from the controller 80 for the medicine dispensing apparatus 10 in that state (see the medicine feeder storage portion 20C in the lower row, among the three upper to lower rows illustrated in FIGS. 1 and 3E), an individual container prepared individually is accordingly placed under the one medicine feeder 52 to be subjected to remaining medicine collection, and the medicine feeder 52 continues discharge operation until the medicine feeder 52 is emptied.

With the “individual container-use remaining medicine collection”, it is difficult to collect remaining medicines concurrently from a plurality of general-purpose medicine feeders 52, and the number of medicine feeders 52 as the target for remaining medicine collection is basically limited to one at a time. The container to be used is not strictly limited, and may be a general-purpose cup, glass, etc. as long as the container is not broken, spotted, etc.

Coordinated operation of the medicine dispensing person and the controllers 80, 53 performed by the individual container-use collecting portion 55 in response to an operation on the touch panel 15 will be described later in the description of operation with reference to screen display examples (see FIGS. 8B to 8E).

In contrast to the method of “individual container-use remaining medicine collection”, there is a method of “remaining medicine collection with use of remaining medicine collecting container for shelf capable of collectively collecting remaining medicines from one drawer shelf”. This method is executed by the shelf container-use collecting portion 56 implemented in the controller 53. The shelf container-use collecting portion 56 also functions as the third remaining medicine collecting means to be activated through an operation on the touch panel 15 and the fourth remaining medicine collecting means to be activated in response to output from the remaining medicine collecting container detecting portion 127 without using the touch panel 15. The shelf container-use collecting portion 56 functioning as the fourth remaining medicine collecting means to be activated in response to detection by the remaining medicine collecting container detecting portion 127 is activated in a different manner (see FIG. 8A), but performs control so as to collect remaining medicines concurrently from the plurality of general-purpose medicine feeders 52, . . . , 52 mounted in one medicine feeder storage portion (20A to 20C) after being activated. Since it is assumed that the shelf container-use collecting portion 56 uses a remaining medicine collecting container 100 corresponding to one medicine feeder storage portion (20A to 20C), the configuration of the remaining medicine collecting container 100 as a shelf container will be described before describing the functions etc. of the shelf container-use collecting portion 56.

The remaining medicine collecting container 100 (see FIG. 9) is separate from the medicine dispensing apparatus 10, and includes a plate-like portion 101 in a long plate shape to be removably attachable to the lower surface of the medicine feeder storage portion (20A to 20C) as a base body. A plurality of (four in the present example) openings 102 are formed in the plate-like portion 101 in correspondence with the arrangement of the medicine feeders 52 in the medicine feeder storage portion (20A to 20C), and remaining medicine containing portions 103 (container portions) are coupled under the respective openings 102. In the remaining medicine collecting container 100, medicines put into the openings 102 from above are separately contained in a plurality of (four in the present example) remaining medicine containing portions 103.

Sets (three sets in the present example) of two permanent magnets 104 and one container-side mark 105 are provided on the upper surface of the plate-like portion 101 of the remaining medicine collecting container 100 in each space between two remaining medicine containing portions 103 (see FIGS. 9A and 9B). The two permanent magnets 104 are fixed to the upper surface of the plate-like portion 101 by screwing etc., and generate a magnetic force to hold the remaining medicine collecting container 100 on the lower surface of the drawer shelf 23 (drawer mechanism) of the medicine feeder storage portion (20A to 20C). The container-side marks 105 correspond to shelf-side marks 26 of the medicine feeder storage portion (20A to 20C), as will be discussed later, in number, position, and direction. In the present embodiment, the container-side marks 105 are arrows. Shelf-side marks 26 are provided on one of side surfaces of the drawer shelf 23 in the width direction located on the remaining medicine collecting container 100 side (see FIGS. 10A to 10C). As illustrated in FIG. 10B, the shelf-side marks 26 according to the present embodiment are arrows directed downward.

The shapes and the positions of the container-side marks 105 and the shelf-side marks 26 are determined such that, when the remaining medicine collecting container 100 is moved to a location under the drawer shelf 23 of the medicine feeder storage portion (20A to 20C) with the arrows of the container-side marks 105 and the shelf-side marks 26 facing each other and attracted to the drawer shelf 23 by a magnetic force, the openings 102 (four openings 102 in the present example) of the remaining medicine collecting container 100 are located in one-to-one correspondence with the medicine discharge ports 23a of the general-purpose medicine feeders 52 (four feeders 52 in the present example) mounted on the drawer shelf 23 (see FIGS. 10C and 11A).

A handle 106 that serves to carry etc. the remaining medicine collecting container 100 is provided on one of side surfaces of the remaining medicine collecting container 100 in the width direction, which is orthogonal to the longitudinal direction, located closer to the marks 105 (see FIGS. 9A and 9B). An alignment portion 107 in the shape of a small protrusion is formed on a side surface of the remaining medicine collecting container 100 on the opposite side (see FIG. 9C). An end portion of the alignment portion 107 is bent toward the remaining medicine containing portions 103 so as to smoothly position the remaining medicine collecting container 100 with the alignment portion 107 being placed on a positioning member 128 (see FIG. 10C), as will be discussed later, of the medicine feeder storage portion (20A to 20C). The alignment portion 107 also functions as a target to be detected by the remaining medicine collecting container detecting portion 127 which includes a detection sensor such as a photosensor. When the alignment portion 107 is located in front of a detection portion of the remaining medicine collecting container detecting portion 127, the remaining medicine collecting container detecting portion 127 detects that the remaining medicine collecting container 100 is mounted.

The medicine feeder storage portion (20A to 20C) in any of the upper, middle, and lower rows (see FIG. 10), to the lower surface of which the remaining medicine collecting container 100 is removably attachable, is formed using a magnetic body such as iron, at least at portions of the drawer shelf 23 to which the permanent magnets 104 are removably attached, as mount-unmount means for mounting and unmounting the remaining medicine collecting container 100 to and from the drawer shelf 23 include the permanent magnets 104.

Since it is common to use an iron material for members such as the drawer shelf 23 and the housing 10A, a magnetic body such as an iron plate is also used for side surfaces etc. of the outer surface portions of the housing 10A.

In addition, when the remaining medicine collecting container 100 is mounted under the drawer shelf 23 (drawer mechanism) of the medicine feeder storage portion 20 with the marks 26 of the medicine feeder storage portion 20 and the marks 105 of the medicine dispensing apparatus 10 correspondingly to face each other (see FIG. 10B), as discussed above, the openings 102 of the remaining medicine containing portions 103 of the remaining medicine collecting container 100 (see FIG. 11A) are located in one-to-one correspondence with the medicine discharge ports 23a of the general-purpose medicine feeders 52 mounted in the medicine feeder storage portion 20 (see FIG. 10C). The medicine discharge ports 23a are intended to feed medicines discharged from the medicine feeders 52 to the medicine receiving ports 32 of the upper medicine collecting portion 30 when the medicine feeder storage portion 20A to 20C is pushed into the housing.

Further, when the remaining medicine collecting container 100 is mounted to the drawer shelf 23 of the medicine feeder storage portion 20 with the marks 105, 26 corresponding to each other as discussed above (see FIG. 10), and the remaining medicine collecting container 100 is moved closer to and pushed against the medicine feeder storage portion 20 and further the alignment portion 107 is moved closer to the remaining medicine collecting container detecting portion 127 (see FIG. 10C) after the alignment portion 107 is placed on the positioning member 127 and stabilized, the alignment portion 107 of the remaining medicine collecting container 100 is reliably located at the spot to be detected by the remaining medicine collecting container detecting portion 127, and some of the plurality of openings 102 of the plurality of remaining medicine containing portions 103 are exposed (see FIG. 11A) to allow visually checking the state of collection of remaining medicines.

In such a mount state, moreover, a part of the remaining medicine collecting container 100 interferes with a part of the medicine feeder storage portion 20 to suppress misalignment therebetween, and interference between the alignment portion 107 and the positioning member 128 highly reliably prevents the occurrence of an undesirable event that the remaining medicine collecting container 100 falls onto the floor, even in a situation in which the remaining medicine collecting container 100 is almost separated from the drawer shelf 23 by the application of an unexpected external force exceeding the magnetic force of the permanent magnets 104 etc. In addition, the remaining medicine collecting container 100 is located in front of the upper medicine collecting portion 30 (see FIG. 11B), which reliably prevents the upper medicine collecting portion 30 from being unexpectedly drawn out.

The medicine feeder storage portions 20A to 20C (see FIG. 10C) are each provided with the remaining medicine collecting container detecting portion 127. The remaining medicine collecting container detecting portion 127 detects whether or not the removable remaining medicine collecting container 100 is mounted from below under the medicine discharge ports 23a of the general-purpose medicine feeders 52 mounted on the drawer shelf 23 (drawer mechanism). In addition, when the remaining medicine collecting container 100 is mounted under the drawer shelf 23 of the medicine feeder storage portion 20 with the marks 105 corresponding to the marks 26, the plurality of openings 102 of the remaining medicine collecting container 100 face the medicine discharge ports 23a of the medicine feeders 52, and mounting of the remaining medicine collecting container 100 is detected by the remaining medicine collecting container detecting portion 127.

Next, the function etc. of the shelf container-use collecting portion 56 to control “remaining medicine collection with use of remaining medicine collecting container”, which is performed by temporarily mounting the remaining medicine collecting container 100 to the medicine feeder storage portion (20A to 20C), will be described (see FIG. 8A). The shelf container-use collecting portion 56 (third and fourth remaining medicine collection methods) performs control collecting for remaining medicines concurrently from the plurality of medicine feeders 52 mounted in one medicine feeder storage portion (20A to 20C) through cooperation with the controller 80. It is assumed that the remaining medicine collecting container 100 including the plurality of remaining medicine containing portions 103 arranged in correspondence with the arrangement of the plurality of medicine feeders 52 is temporarily mounted. After the remaining medicine collecting container 100 is mounted, remaining medicines are automatically discharged from the medicine feeders 52 in the medicine feeder storage portion 20 to which the remaining medicine collecting container 100 has been mounted, to collect the remaining medicines in the remaining medicine collecting container 100.

Specifically, when “collect with shelf container” is selected through an operation on the touch panel 15 (see FIG. 12A), the controller 80 executes the discharge operation mode select portion 81 and the controller 53 executes the shelf container-use collecting portion 56 to implement the “third remaining medicine collecting means” through cooperation of the controllers 80 and 53. In this case, a remaining medicine collecting instruction to release remaining medicines is provided from the controller 80 to the plurality of general-purpose medicine feeders 52 in units of medicine feeder storage portion (20 to 20C). The medicine feeder storage portion (20 to 20C) permitted to be drawn out since medicines have been completely discharged therefrom can be manually drawn forward out of the housing 10A with the relevant drawer lock mechanism 40 being unlocked. When the medicine feeder storage portion (20 to 20C) that can be drawn out is drawn forward out of the housing 10A, the controller 80 can determine and confirm that the medicine feeder storage portion has been drawn out on a basis of the state of detection by the drawn state detecting portion (FIG. 6B).

Moreover, the touch panel 15 makes an indication to suggest mounting the remaining medicine collecting container 100 under the medicine feeder storage portion (20 to 20C) that has been drawn out (see FIG. 12B). When the remaining medicine collecting container 100 which is empty is appropriately mounted to the medicine feeder storage portion (20 to 20C) to be subjected to remaining medicine collection according to the indicated suggestion (see FIGS. 10 and 11), the remaining medicine collecting container detecting portion 127 of the medicine feeder storage portion (20 to 20C) to which the remaining medicine collecting container 100 has been mounted detects the fact that the remaining medicine collecting container 100 has been mounted and the medicine feeder storage portion to which the remaining medicine collecting container 100 has been mounted. In response to this detection, remaining medicine collecting operation automatically progresses for the relevant medicine feeders 52 (see FIG. 12C). When all the medicine feeders 52 to be subjected to collection are emptied, it is determined that remaining medicine collection has been completed, and it is suggested to detach the remaining medicine collecting container 100 (see FIG. 12D).

When the remaining medicine collecting container detecting portion 127 detects that the remaining medicine collecting container 100 is mounted to the medicine feeder storage portion (20 to 20C) (see FIGS. 10A, 10C, 11A, and 8A) while the drawn state detecting portion (FIG. 6B) detects that the medicine feeder storage portion (20 to 20C) is drawn out of the housing 10A, the shelf container-use collecting portion 56 functions as the “fourth remaining medicine collecting means” according to choice by the discharge operation mode select portion 81. In this case, remaining medicine collecting operation automatically progresses (see FIG. 12C) for the relevant medicine feeders 52 immediately without selection of the collection method (see FIG. 12A) or suggestion of mounting of the remaining medicine collecting container 100 (see FIG. 12A), unlike the third remaining medicine collecting means discussed above. When all the medicine feeders 52 to be subjected to collection are emptied, it is determined that remaining medicine collection has been completed, and it is suggested to detach the remaining medicine collecting container 100 (see FIG. 12D).

Further, the medicine dispensing apparatus 10 does not always perform remaining medicine collecting operation for all of a plurality of (four in the illustrated example) general-purpose medicine feeders 52 to be subjected to remaining medicine collection performed using the remaining medicine collecting container 100, irrespective of whether the shelf container-use collecting portion 56 is caused to operate as the third remaining medicine collecting means through an operation on the touch panel 15 or to operate as the fourth remaining medicine collecting means in response to detection by the remaining medicine collecting container detecting portion 127, even without the need to receive an operation on the touch panel 15. The controllers 80, 53 of the medicine dispensing apparatus 10 according to the present embodiment cause only medicine feeders 52 that have already discharged medicines based on a medicine dispensation instruction but that have not been subjected to remaining medicine collecting operation yet to perform remaining medicine collecting operation. It is easy to determine whether or not a medicine feeder 52 has discharged medicines but has not been subjected to remaining medicine collecting operation, by referencing the record data discussed above. The controllers 80, 53 reference the record data.

Completion of remaining medicine collection can be determined based on the fact that the medicine feeders 52 have been emptied, and it can be relatively easily detected that the medicine feeders 52 have been emptied based on the expiration (time over, timeout) etc. of a waiting time for detection of falling medicines.

“Remaining medicine collection with use of remaining medicine collecting container 100”, which requires preparing the remaining medicine collecting container 100 as a container to be used, is efficient since remaining medicines can be concurrently collected from the plurality of medicine feeders 52, and facilitates management of collected medicines since the correlation is maintained between the medicine feeders 52 arranged in the medicine feeder storage portion (20A to 20C) and the remaining medicine containing portions 103 in the remaining medicine collecting container 100.

Coordinated operation (operation of the third remaining medicine collecting means) of the controllers 80, 53 and the medicine dispensing person performed by the shelf container-use collecting portion 56 in response to an operation on the touch panel 15 and coordinated operation (operation of the fourth remaining medicine collecting means) of the controllers 80, 53 performed in response to the remaining medicine collecting container detecting portion 127 detecting a container without the need for an operation on the touch panel 15 by the medicine dispensing person also will be briefly described in the following description of operation with reference to screen display examples (see FIGS. 12A to 12D).

The mode of use and the operation of the medicine dispensing apparatus 10 according to the present embodiment will be described with reference to FIGS. 1 to 12 discussed above.

When a medicine dispensation instruction is transmitted from the medicine dispensing server 200 to the medicine dispensing apparatus 10 through an operation on the touch panel 15 etc. (see FIG. 1) and the medicine dispensation instruction is received by the controller 80 of the medicine dispensing apparatus 10, the content of the medicine dispensation instruction is displayed on the touch panel 15 for confirmation. When such display is made, and when medicines indicated in the medicine dispensation instruction to be automatically dispensed are stored in the medicine feeder 51 in the medicine feeder storage 14, the medicines are automatically appropriately allocated by the controller 80 to complete preparation. After that, when the medicine dispensing person makes a confirmation by operating the touch panel 15, medicines to be dispensed are automatically discharged from the medicine feeder 51, collected while falling to reach the packing device 11, and separately stored in dispensing paper.

When the medicines to be automatically dispensed can be handled by some of the medicine feeders 51 exclusively for specific medicines but do not happen to be stored in any of the medicine feeders 51, the medicines to be dispensed are put into the relevant medicine feeder 51, the medicines to be dispensed are put into a selected one of the general-purpose medicine feeders 52, or the medicines to be dispensed are manually dispensed using the manual medicine dispensing device 12. In this example, the touch panel 15 displays an indication to inquire the medicine dispensing person which of the options to take (not illustrated), and thus the medicine dispensing person normally selects a possible one of the options in the mentioned order from the viewpoint of convenience, efficiency, etc.

When the medicine dispensing person selects the medicine feeder 51, automatic medicine dispensation is performed as discussed above when a panel operation for confirmation is performed after the medicines to be dispensed are put into the medicine feeder 51.

When the medicine feeder 51 cannot be used, the medicine feeder 52 is selected rather than the manual medicine dispensing device 12, if the medicine feeder 52 is empty and available for use (called “choice to charge medicines into general-purpose medicine feeder 52” in the following reference).

In the medicine dispensing apparatus 10 according to the present embodiment, a list of the names of medicines, the number of medicines prescribed, the medicine feeder 52 that is available for use, etc. is displayed on the screen of the touch panel 15, and thus an appropriate medicine feeder 52 is selected through a screen operation. Then, operation to unlock the drawer lock mechanism 40 of the medicine feeder storage portion in which the selected medicine feeder 52 is mounted is performed to enable the relevant medicine feeder storage portion to be drawn out, and that fact is indicated through screen display etc. The medicine dispensing person draws out the medicine feeder storage portion which has been enabled to be drawn out (see FIG. 3E), and medicines are put into the relevant medicine feeder 52 indicated through screen display etc. (see FIG. 4A) by opening and closing the lid 52a. At this time, a number of medicines are input, the number being specified in the medicine dispensation instruction, or a greater number of medicines are input.

After that, the medicine dispensing person pushes back the medicine feeder storage portion (20A to 20C), in which the general-purpose medicine feeder 52 into which medicines have been put is mounted, into the housing 10A of the medicine dispensing apparatus 10, checks that the medicine feeder storage portion is locked by the drawer lock mechanism 40, and thereafter causes the medicine dispensing apparatus 10 to start automatic medicine dispensation through a screen operation on the touch panel 15 etc. After the start of automatic medicine dispensation, an appropriate number of medicines are discharged from the appropriate medicine feeder 51, 52 according to the prescription instruction in any case, and further packed by the packing device 11. When extra medicines remain in the medicine feeder 52 that has been subjected to medicine dispensation after medicine dispensation is finished according to the prescription instruction in this manner, the remaining medicines are collected to empty the feeder 52 to be used in dispensation of other medicines in most cases, except for a lucky case where the remaining medicines can also be used in the subsequent dispensation of different medicines.

When the medicine dispensing apparatus 10 does not have any other prescription instruction, or when the medicine dispensing apparatus 10 has a different prescription instruction but it is not necessary to immediately start the medicine dispensation, a “UF collection” screen for collecting remaining medicines from the medicine feeder 52 is displayed through an operation on the touch panel 15 (see FIG. 8B). After that, when “pack and collect” is selected, remaining medicines are packed in dispensing paper and collected immediately and easily, even without the need to draw the relevant medicine feeder 52 and the medicine feeder storage portion out of the housing 10A of the medicine dispensing apparatus 10, under control (operation of the first remaining medicine collecting means) through coordinated operation of the discharge operation mode select portion 81 of the controller 80 for the medicine dispensing apparatus 10 and the automatic discharge portion 54 of the controller 53 for the medicine feeder 52.

When it is desired to cause the medicine dispensing apparatus 10 to urgently perform different automatic medicine dispensation according to the different prescription instruction, or when it is not desired in the first place to collect remaining medicines using dispensing paper, the medicine dispensing person operates the touch panel 15 to display a “UF collection” screen for collecting remaining medicines from the medicine feeder 52. Next, one of “collect with individual container” and “collect with shelf-specific container” is selected as the remaining medicine collection method. Here, first, description is made of a case where “collect with individual container” (operation of the second remaining medicine collecting means) for which a special container is not required and a general-purpose cup, glass, etc. can be used is selected (see FIG. 8B). When this selection is made, a screen that requests selection of the medicine feeder 52 to be subjected to remaining medicine collection is displayed on the touch panel 15 (see FIG. 8C), and thus the medicine dispensing person performs an operation to specify the target medicine feeder 52 (in the example in FIG. 8C, “12” which indicates the second medicine feeder 52 from the front in the medicine feeder storage portion 20C in the lowermost row is selected). After that, the medicine feeder storage portion 20C in the lower row in which the medicine feeder 52 to be subjected to remaining medicine collection is specified (“UF1 shelf” in the example in FIG. 8D), and a screen that provides an instruction to draw out the medicine feeder storage portion 20C is displayed on the touch panel 15 (see FIG. 8D).

Then, the drawer lock mechanism 40 provided for the medicine feeder storage portion 20C is unlocked, and thereafter the medicine feeder storage portion 20C is drawn forward out of the housing 10A (see the medicine feeder storage portion 20C in the lowermost row in FIGS. 1 and 3A).

When the relevant drawer shelf is unlocked and further it is detected that the drawer shelf has been drawn out forward with respect to the locked position, it is determined that the medicine feeder 52 to be subjected to remaining medicine collection has been sufficiently drawn out of the housing 10A, and a screen that prompts the medicine dispensing person to place a collecting container under the medicine feeder 52 to be subjected to remaining medicine collection is displayed on the touch panel 15 (see FIG. 8E). This display allows the medicine dispensing person to immediately and adequately place a collecting container under the medicine feeder 52 to be subjected to remaining medicine collection (not illustrated).

When the medicine dispensing person provides an instruction to “start” remaining medicine collection through a screen operation on the touch panel 15 (see the lower right portion of the screen display example in FIG. 8E), the controller 53 executes the individual container-use collecting portion 55 under control by the controller 80, and remaining medicines are immediately moved into the collecting container since remaining medicines are discharged downward one after another from the medicine feeder 52 subjected to remaining medicine collection through cooperative control by the controllers.

During discharge of remaining medicines, the lid 52a of the medicine feeder 52 subjected to remaining medicine collection must be closed in order to prevent undesired scattering of medicines etc. When discharge is completed, however, the completion of the discharge is detected on a basis of the expiration etc. of a waiting time for detection of falling medicines, and the lid 52a is unlocked. Thus, the medicine dispensing person opens the lid 52a of the medicine feeder 52 subjected to remaining medicine collection, if possible, to check the presence or absence of remaining medicines with his/her eyes (see FIG. 4B).

When it is confirmed that the medicine feeder 52 subjected to remaining medicine collection has been reliably emptied, the medicine dispensing person closes the lid 52a so that the emptied medicine feeder 52 is ready for the next use.

In this manner, remaining medicines can be collected from the medicine feeder 52 after automatic discharge into a general-purpose collecting container. In that event, the medicine feeders 52 mounted in the medicine feeder storage portions 20A and 20B (medicine feeder storage portions in the upper and middle rows in the example in FIGS. 1 and 3E) in which the medicine feeder 52 subjected to remaining medicine collection can be concurrently used for automatic dispensation of other medicines according to a different prescription instruction, since medicine discharge operation is not affected by whether the medicine feeder storage portion 20C (medicine feeder storage portion in the lower row in the example in FIGS. 1 and 3E) in which the medicine feeder 52 subjected to remaining medicine collection is mounted is housed in the housing 10A of the medicine dispensing apparatus 10 or projects forward from the housing 10A.

Further, description is made of a case where “collect with shelf container”, rather than “collect with individual container”, is selected as the remaining medicine collection method (see FIG. 12A) when a “UF collection” screen for collecting remaining medicines from the medicine feeder 52 through an operation on the touch panel 15 by the medicine dispensing person is displayed (see FIGS. 8B and 12A).

The constitution for this case (third remaining medicine collecting means) has already been discussed in detail, and thus the method of use and operation will be briefly discussed in order to facilitate understanding. First, the medicine dispensing person selects “collect with shelf container” on the touch panel 15 (see FIG. 12A), and draws a relevant one of the medicine feeder storage portions 20A to 20C, which has been accordingly unlocked, forward out of the housing 10A.

Then, guidance that suggests mounting the remaining medicine collecting container 100 under the medicine feeder storage portion which has been drawn out is displayed on the touch panel 15 (see FIG. 12B). In response to this display, the medicine dispensing person executes mounting of an empty remaining medicine collecting container 100.

After that, in the medicine dispensing apparatus 10, appropriate mounting of the remaining medicine collecting container 100 to the medicine feeder storage portion is automatically detected, and remaining medicines are collected for a medicine feeder 52 from which medicines have already been discharged but for which remaining medicine collecting operation has not been performed yet (see FIG. 12C). When collection of remaining medicines is completed, a suggestion is made to detach the remaining medicine collecting container 100 (see FIG. 12D).

In this manner, while the medicine dispensing person is involved in selection of the collection method and mounting of the remaining medicine collecting container 100, the subsequent remaining medicine collecting operation is automatically performed. Thus, the medicine dispensing person is released from the remaining medicine collecting work shortly, and can immediately transition to the work of dispensing other medicines etc.

For example, when remaining medicines are collected from the plurality of medicine feeders 52 in the medicine feeder storage portion 20C in the lower row into the remaining medicine collecting container 100 and a state in which the work of collecting remaining medicines is automatically continued is established, the medicine dispensing person can perform the work of making preparations for the next automatic medicine dispensation such as putting medicines into the medicine feeders 52 in the medicine feeder storage portions 20A and 20B in the upper and middle rows, and return to the work of detaching the remaining medicine collecting container 100 from the medicine feeder storage portion 20C in the lower row at an appropriate time.

Remaining medicine collection performed with the remaining medicine collecting container 100 being mounted to the medicine feeder storage portion is automatically started upon detecting that the medicine feeder storage portion is drawn out of the housing and that the remaining medicine collecting container 100 is mounted to the medicine feeder storage portion as discussed above. Remaining medicine collection in this case (operation of the fourth remaining medicine collecting means) is started without a manual operation on the touch panel 15 etc., and moreover started only on condition that the medicine feeder storage portion is sufficiently drawn forward and that the remaining medicine collecting container 100 is appropriately mounted to the medicine feeder storage portion, and thus can be applied in many scenes such as not only situations assumed in advance but also unexpected situations.

Typical examples of the assumed situations include remaining medicine collection with use of remaining medicine collecting container 100 (operation of the fourth remaining medicine collecting means) executed after the “choice to charge medicines into general-purpose medicine feeder 52” discussed above and before execution of charge of medicines.

Specifically, the medicine dispensing person selects to charge medicines into the medicine feeder 52 through an operation on the touch panel 15 as discussed above, and manually draws the relevant medicine feeder storage portion (20A to 20C) forward out of the housing 10A after the drawer lock mechanism 40 of the relevant medicine feeder storage portion is accordingly unlocked. It is only necessary to mount the remaining medicine collecting container 100 to the medicine feeder storage portion to automatically perform remaining medicine collection, and further to detach the remaining medicine collecting container 100 after collection, when it is desired to execute remaining medicine collection before charge of medicines. The work of charging medicines into the medicine feeder 52 may be performed after that.

In this manner, the medicine dispensing person can determine as desired whether or not to perform remaining medicine collection with use of the remaining medicine collecting container 100 before charge of medicines into the medicine feeder 52, and the determination timing can be delayed to immediately before execution of charge of medicines into the medicine feeder 52, which reduces the burden on the medicine dispensing person and is highly practical.

When an instruction is provided again to execute remaining medicine collection from the medicine feeder 52 in the medicine feeder storage portion (20A to 20C) even if such remaining medicine collection has already been completed, either using the remaining medicine collecting container 100 or using a different individual container etc., record data are referenced before execution of remaining medicine collection. In the present embodiment, the medicine feeder 52 to be subjected to execution of remaining medicine collection is limited to “medicine feeders having discharged medicines based on the medicine dispensation instruction but not having discharged medicines to collect remaining medicines thereafter” based on the data, and thus an attempt at remaining medicine collection can be casually made without spending time for checking work even when it is desired to check whether or not remaining medicines have already been collected.

Finally, handling of the remaining medicine collecting container 100 after use will be described. As discussed above, a magnetic body such as iron is used for side plates of the housing 10A of the medicine dispensing apparatus 10. Thus, the remaining medicine collecting container 100 can be temporarily attached to the medicine dispensing apparatus 10 by bringing the permanent magnets 104 of the remaining medicine collecting container 100 into abutment with a side plate of the housing 10A of the medicine dispensing apparatus 10 when the remaining medicine collecting container 100 is not in use (see FIG. 12E), which allows the remaining medicine collecting container 100 to be conveniently stored without constituting an obstruction and further immediately detached to be used when necessary.

### Others

In the above embodiment, the medicine dispensing apparatus 10 includes the controller 80, the medicine feeders 52 include the individual controllers 53, and such controllers constitute the control portion. However, it is not essential that the medicine feeders 52 should include the individual controllers 53. For example, a single controller or a small number of controllers may serve as the control portion for the plurality of medicine feeders 52, or the control portion for the medicine dispensing apparatus 10 may also serve as the control portion for the medicine feeders 52 by a method such as installing a program for performing the function of the controllers 53 in the controller 80 for the medicine dispensing apparatus 10. A program for configuring the individual container-use collecting portion 55 and a program for configuring the shelf container-use collecting portion 56 can also be installed in the controller 80.

In the above embodiment, the degree of progress is displayed on the touch panel 15 to inform the medicine dispensing person (see FIGS. 12C and 12D) when the shelf container-use collecting portion 56 functions as the third remaining medicine collecting means and functions as the fourth remaining medicine collecting means under control by the discharge operation mode select portion 81. However, remaining medicine collection takes only several tens of seconds, and is momentarily finished when all the target medicine feeders 52 have already been subjected to remaining medicine collection, and thus there would be no inconvenience if display or a notification of the degree of progress illustrated in the drawings were omitted.

The medicine dispensing apparatus according to the present invention may be of a stand-alone type that is not based on coordination with an upper-level device such as a medicine dispensing server as long as the medicine dispensing apparatus includes means for acquiring medicine dispensation instruction data.

### INDUSTRIAL APPLICABILITY

In the medicine dispensing apparatus according to the present invention, when it is automatically confirmed for a general-purpose medicine feeder that the relevant medicine feeder has been drawn forward out of the housing and that a remaining medicine collecting container has been mounted in correspondence with the medicine discharge port, medicines are discharged from the relevant medicine feeder. Thus, it is automatically confirmed whether or not remaining medicine collecting operation can be performed, and remaining medicine collecting operation can be automatically performed once such operation is started. Therefore, a human burden required for remaining medicine collection can be significantly reduced.

### DESCRIPTION OF REFERENCE NUMERALS

10 medicine dispensing apparatus
10A housing
11 packing device
12 manual medicine dispensing device
13 medicine storage portion
14 medicine feeder storage (storage for medicine feeders exclusively for specific medicines)
15 touch panel (operation input portion, display portion of medicine dispensing apparatus)
16, 16a lower medicine collecting portion
17 upper medicine collecting portion
18 medicine feeder storage portion (for medicine feeders exclusively for specific medicines)
20 medicine feeder storage portion (for medicine feeders adaptable to many types of medicines)
21 handle
22 drawer mechanism
23 drawer shelf
23a medicine discharge port
24 movable rack
25 front plate
26 mark (mark for alignment)
29 lid open-close state detecting portion (magnetic sensor)
30 upper medicine collecting portion
31 body portion
32 medicine receiving port
33 handle
34 side plate holding member
35 side plate
36 retention member
37 multi-row drawer mechanism
40 drawer lock mechanism
41 electromagnetic driving portion
42 advancing-retracting member (engagement member)
43 manual lock
44 swing member (engagement member)
45 key
51 medicine feeder
51a cassette (container portion)
51b base (driving portion)
52 medicine feeder
52a lid
53 controller (control portion for medicine feeders adaptable to many types of medicines, general-purpose medicine feeders)
54 automatic discharge portion
55 individual container-use collecting portion
56 shelf container-use collecting portion
80 controller (control portion for medicine dispensing apparatus)
81 discharge operation mode select portion
100 remaining medicine collecting container
101 plate-like portion
102 opening
103 remaining medicine containing portion
104 permanent magnet (mount-unmount means)
105 mark (mark for alignment)
106 handle
107 alignment portion (detected portion)
127 remaining medicine collecting container detecting portion
128 positioning member
200 medicine dispensing server

1. A medicine dispensing apparatus comprising:
a plurality of medicine feeders each including a container portion for containing a large number of medicines in a random manner and a successive discharge mechanism portion operable to drop and discharge the large number of medicines one by one downward from the container portion;
a packing device operable to receive and pack the medicines discharged from the plurality of medicine feeders;
a housing capable of accommodating the plurality of medicine feeders and the packing device; and
a control portion configured to control operation of the plurality of medicine feeders and the packing device, wherein:
the plurality of medicine feeders include a plurality of general-purpose medicine feeders each constituted by integrating the container portion and the successive discharge mechanism portion;
the plurality of general-purpose medicine feeders are separately mounted on a plurality of drawer shelves that are drawable forward out of the housing;
the plurality of drawer shelves are each provided with a drawn state detecting portion configured to detect a drawn state of the drawer shelf and a remaining medicine collecting container detecting portion configured to detect whether or not a removable remaining medicine collecting container is mounted ahead of a medicine discharge port of one or more general-purpose medicine feeders, among the plurality of general-purpose medicine feeders mounted on the drawer shelf that has been drawn out; and
when the remaining medicine collecting container detecting portion detects that the remaining medicine collecting container is mounted to the one or more general-purpose medicine feeders mounted on the drawer shelf that has been drawn out when the drawn state detecting portion detects that the drawer shelf is drawn out forward, the control portion causes the applicable general-purpose medicine feeders to execute remaining medicine discharge operation.

2. The medicine dispensing apparatus according to claim 1, wherein:
the control portion includes:
a medicine dispensation instruction receiving portion configured to receive a medicine dispensation instruction, and
a remaining medicine collecting instruction receiving portion configured to receive a remaining medicine collecting instruction for instructing the plurality of general-purpose medicine feeders to release remaining medicines in a state of being drawn out forward; and
when the drawn state detecting portion detects that the drawer shelf is drawn out forward and the remaining medicine collecting container detecting portion detects that the remaining medicine collecting container is mounted, the remaining medicine collecting instruction receiving portion causes the corresponding general-purpose medicine feeders to execute the remaining medicine discharge operation.

3. The medicine dispensing apparatus according to claim 1, wherein
the remaining medicine collecting container includes a plurality of remaining medicine collecting portions corresponding to all the general-purpose medicine feeders mounted on one of the drawer shelves.

4. The medicine dispensing apparatus according to claim 3, wherein:
the drawer shelf is provided with one or more shelf-side marks for alignment corresponding to one or more container-side marks provided on the remaining medicine collecting container; and
the drawer shelf and the remaining medicine collecting container are configured such that, when the remaining medicine collecting container is mounted on the drawer shelf with the one or more container-side marks corresponding to the one or more shelf-side marks, openings of the plurality of remaining medicine collecting portions of the remaining medicine collecting container face medicine discharge ports of the plurality of general-purpose medicine feeders and the remaining medicine collecting container detecting portion detects that the remaining medicine collecting container is mounted.

5. The medicine dispensing apparatus according to claim 3, wherein
the drawer shelf and the remaining medicine collecting container are configured such that a part of the remaining medicine collecting container is engaged with a part of the drawer shelf to suppress misalignment between the remaining medicine collecting container and the drawer shelf when the remaining medicine collecting container is mounted on the drawer shelf with the one or more container-side marks and the one or more shelf-side marks corresponding to each other.

6. The medicine dispensing apparatus according to claim 3, wherein
the drawer shelf and the remaining medicine collecting container are configured such that some of openings of the plurality of remaining medicine collecting portions of the remaining medicine collecting container are exposed when the remaining medicine collecting container is mounted on the drawer shelf with the one or more container-side marks and the one or more shelf-side marks corresponding to each other.

7. The medicine dispensing apparatus according to claim 3, wherein
the drawer shelf and the remaining medicine collecting container are configured to be removably attached through mount-unmount means that uses a magnetic force of one or more permanent magnets.

8. The medicine dispensing apparatus according to claim 7, wherein:
the one or more permanent magnets are mounted to the remaining medicine collecting container; and
a mount-unmount portion of the drawer shelf is formed from a magnetic material.

9. The medicine dispensing apparatus according to claim 8, wherein
a part of the housing is formed from a magnetic material so that the remaining medicine collecting container is mountable thereto using the magnetic force when the remaining medicine collecting container is not in use.

10. The medicine dispensing apparatus according to claim 2, wherein:
the control portion includes data holding means for holding record data about some of the plurality of general-purpose medicine feeders having discharged medicines based on a medicine dispensation instruction and record data about others of the plurality of general-purpose medicine feeders having discharged medicines for collecting remaining medicines; and
the control portion limits the remaining medicine discharge operation to general-purpose medicine feeders having discharged medicines based on the medicine dispensation instruction but not having discharged medicines for collecting remaining medicines thereafter by referencing the record data.

11. The medicine dispensing apparatus according to claim 2, wherein
the remaining medicine collecting container includes a plurality of remaining medicine collecting portions corresponding to all the general-purpose medicine feeders mounted on one of the drawer shelves.

12. The medicine dispensing apparatus according to claim 11, wherein:
the drawer shelf is provided with one or more shelf-side marks for alignment corresponding to one or more container-side marks provided on the remaining medicine collecting container; and
the drawer shelf and the remaining medicine collecting container are configured such that, when the remaining medicine collecting container is mounted on the drawer shelf with the one or more container-side marks corresponding to the one or more shelf-side marks, openings of the plurality of remaining medicine collecting portions of the remaining medicine collecting container face medicine discharge ports of the plurality of general-purpose medicine feeders and the remaining medicine collecting container detecting portion detects that the remaining medicine collecting container is mounted.

13. The medicine dispensing apparatus according to claim 11, wherein
the drawer shelf and the remaining medicine collecting container are configured such that a part of the remaining medicine collecting container is engaged with a part of the drawer shelf to suppress misalignment between the remaining medicine collecting container and the drawer shelf when the remaining medicine collecting container is mounted on the drawer shelf with the one or more container-side marks and the one or more shelf-side marks corresponding to each other.

14. The medicine dispensing apparatus according to claim 11, wherein
the drawer shelf and the remaining medicine collecting container are configured such that some of openings of the plurality of remaining medicine collecting portions of the remaining medicine collecting container are exposed when the remaining medicine collecting container is mounted on the drawer shelf with the one or more container-side marks and the one or more shelf-side marks corresponding to each other.

15. The medicine dispensing apparatus according to claim 11, wherein
the drawer shelf and the remaining medicine collecting container are configured to be removably attached through mount-unmount means that uses a magnetic force of one or more permanent magnets.

16. The medicine dispensing apparatus according to claim 15, wherein:
the one or more permanent magnets are mounted to the remaining medicine collecting container; and
a mount-unmount portion of the drawer shelf is formed from a magnetic material.

17. The medicine dispensing apparatus according to claim 16, wherein
a part of the housing is formed from a magnetic material so that the remaining medicine collecting container is mountable thereto using the magnetic force when the remaining medicine collecting container is not in use.
